(19) United States
(12) Patent Application Publication
(10) Pub. No.: US 2011/0036919 A1
(43) Pub. Date: Feb. 17, 2011

(54) GLOBAL WARMING MITIGATION METHOD

(76) Inventor: JAMES RUSSELL BAIRD, Nanaimo (CA)

Correspondence Address: JAMES RUSSELL BAIRD, 201 3087 BARONS RD., NANAIMO, BC, V9T 3Y6, CA

(21) Appl. No.: 12/838,172

(22) Filed: Jul. 16, 2010

Related U.S. Application Data
(63) Continuation of application No. 12/408,656, filed on Mar. 20, 2009.

(51) Int. Cl. A01G 15/00

(52) U.S. Cl. 239/2.1

(57) ABSTRACT

The present invention provides a method of limiting sea level rise. In a first step heat that would otherwise cause thermal expansion of the ocean and resultant sea level rise is extracted to produce energy. The energy is used to convert a portion of the liquid ocean water to the gaseous elements hydrogen and oxygen by the process of electrolysis. The ocean level is reduced by the volume of water converted to gas. The hydrogen is captured for use as an energy source and is transported to a desert to be recombined with resident oxygen to produce energy and water for irrigation.

This application is a continuation in part of U.S. application Ser. No. 12/408,656, filed on 20 Mar. 2009

### BACKGROUND OF THE INVENTION

1. Field of the Invention

The present invention relates generally to the mitigation of the principal cause and forecasted effects of global warming. More particularly, the present invention relates to a method of conversion of ocean heat to productive energy and to sequestering carbon dioxide and water in a desert environment

2. Description of the Prior Art

Use of the Earth's resources has resulted in global scale environmental problems including elevated atmospheric carbon dioxide concentrations and rising sea levels. As a result of land use change and the burning of fossil fuels, atmospheric carbon dioxide levels are predicted to double in as little as 60 years. It is expected that elevated atmospheric concentrations of carbon dioxide and other greenhouse gases will facilitate greater storage of heat within the atmosphere leading to enhanced surface temperatures and rapid climate change. The impact of unmitigated climate change will likely be economically expensive and environmentally hazardous. One of the most threatening outcomes of unmitigated climate change predicted over the course of the next century is sea level rise of between 90 to 880 mm, with a central value of 480 mm. The water currently held in the world's glaciers is melting and a rise in the Earth's surface temperature is expected to accelerate the process. The melted water flows into the Earth's oceans and, in conjunction with thermal expansion of the oceans due to the rising temperature, raises their levels.

Reducing potential risks of climate change will require conversion of a portion of the increasing thermal load being taken up by the oceans to other forms of energy, and/or the terrestrial taking up of much of the water that would otherwise raise the level of the oceans and inundate populated coastal areas and/or the conversion of a portion of the water that would otherwise inundate coastal areas to its gaseous components hydrogen and oxygen.

Methods proposed to capture and store atmospheric carbon dioxide include storage in geological formations, injection into the deep ocean, and uptake by phytoplankton via fertilization of the ocean. The limited capacity and duration, expense, and environmental outcomes of these methods are largely unresolved and may prohibit their utility.

The most economically and environmentally plausible manner to sequester atmospheric carbon dioxide is to enhance natural sinks. Natural options avoid the costs associated with industrial separation, capture, compression, and storage of carbon dioxide, and reduce potential negative environmental side effects. Natural methods offer reservoirs of large capacity and the ability to replace the carbon from whence it came, the long-term carbon cycle. Enhancing forest growth is an example of a natural method of carbon sequestration that is environmentally benign and, with proper management, allows for the value-added option of sustainable forest harvesting. Many present day activities would have to be disrupted however to return farmlands to forests or wetlands which would increase carbon sequestration. For example loss of farmlands will decrease crop production for food and biofuels.

The largest natural carbon reservoirs include ocean waters and marine sediments. Dissolving carbon dioxide in seawater however increases the hydrogen concentration in the ocean, and thus its acidification. This acidification has negative consequences for oceanic calcifying organisms and may hamper their ability to take up carbon dioxide.

Deserts are dry regions of the planet with sparse vegetation and equally sparse commercial activity. They take up about one third of the Earth's land surface. Roughly two thirds of this is made up of the Antarctic Desert and the Arctic, which due to their cold climate and negligible vegetation have limited capacity to sequester atmospheric carbon dioxide. The other third are hot deserts, which can be irrigated to facilitate the production of value-added crops for food, fuel, and fibre or to produce building materials.

These crops would sequester significant quantities of carbon dioxide.

Deserts can also take up much of the water from melting glaciers that would otherwise add to sea level rise.

A major problem associated with desert irrigation is the water required for irrigation and/or the energy required to pump the water into the desert may be produced remotely enough to make the cost of water transportation and or electrical transmission economically prohibitive.

The world's largest hot deserts are located in the Middle East and North Africa (MENA) where crude oil is the major export commodity. An economical way of transporting water for the irrigation of the deserts of the MENA is as ballast in oil tankers deadheading to their home ports. The global capacity of the world's tanker fleet could carry about the same amount of water as Saudi Arabia is currently desalinating at significant cost.

To bring remote offshore power to where it is needed it may be used to convert ocean water by the process of electrolysis to the energy currency hydrogen and oxygen. This conversion of a portion of the liquid ocean into its gaseous components reduces the level of the rising oceans by the volume of water converted to gas.

Only the hydrogen, which is 1/9th the molecular weight of the water disassociated by the process of electrolysis, needs to be transported to where the energy/water is required and this energy/water can be produced by combining the hydrogen with resident atmospheric oxygen where needed.

This energy and water can be used to irrigate the world's hot deserts for the purpose of carbon dioxide sequestration or for other economic and environmentally beneficial purposes.

Hydrogen in its gaseous state is lighter than air and accordingly would rise due to its natural buoyancy within a pipe or chimney to a high point adjacent or within a desert. Water created by the combining hydrogen and resident oxygen at elevation would then flow back to the desert for irrigation purposes propelled by gravity.

An effective method of carbon dioxide and water sequestration would be to promote the reclamation of the world's hot deserts to arable use. Accordingly, there is a need in the art to develop methods of promoting this reclamation for the purposes of carbon dioxide and water sequestration.

An effective method of utilizing the heat the oceans are absorbing, causing thermal expansion and sea level rise, would be to convert this heat to more productive energy forms. Accordingly, there is a need in the art to develop methods of promoting this conversion of heat to more productive forms of energy for the purpose of limiting sea level rise due to thermal expansion.

Another effective method of mitigating sea level rise is to convert a portion of the ocean to its gaseous component elements hydrogen and oxygen. Accordingly, there is a need in the art to develop methods of disassociating some ocean water into its gaseous components for the purpose of limiting sea level rise.

### SUMMARY OF THE INVENTION

The present invention is concerned with sequestering carbon dioxide and water, and, more specifically, to a method of sequestering carbon dioxide and water in a desert environment. Another concern is the maintenance of sea levels near current levels to prevent inundation of inhabited coastal areas, more specifically, to a method to convert the heat causing thermal expansion of the oceans to a more productive form of energy and to use said energy to convert ocean water into to its gaseous component elements hydrogen and oxygen which in turn produce energy and water when recombined.

An objective of the present invention is to provide a viable, economic and commercial means of stabilizing the level of the world's oceans to avert inundation of many of the world's populated coastal cities.

Another objective of the present invention is to provide a viable, economic and commercial means of curbing the carbon dioxide build up in the atmosphere, which is believed to be contributing to global climate change.

In some embodiments of this invention ocean energy is harnessed.

In some embodiments of this invention energy, in the form of heat, is removed from the ocean to reduce thermal expansion of the oceans.

In some embodiments of this invention ocean energy is converted to electricity.

In some embodiments of this invention electricity is used to convert a portion of the ocean's liquid mass to the gases hydrogen and oxygen by electrolysis.

Another embodiment of this invention lowers ocean levels by converting a portion of the ocean's liquid volume to the gases hydrogen and oxygen.

In some embodiments of this invention the hydrogen produced by the electrolysis of ocean water is used as an energy currency.

In some embodiments of this invention the oxygen produced by the electrolysis of ocean water is used to revive ocean dead zones.

In some embodiments of this invention the oxygen produced by the electrolysis of ocean water combines with hydrogen in the ocean to reduce ocean acidification.

In some embodiments of this invention hydrogen gas is formed under pressure deep within the ocean.

In some embodiments of this invention the energy currency hydrogen is used to fuel tankers that transport hydrogen to a desert.

In some embodiments of this invention buoyancy is used to convey hydrogen up a pipeline to an elevate region in or adjacent a desert.

In some embodiments hydrogen is combined with resident oxygen at an elevated area in or adjacent a desert to produce power and water.

In some embodiments fresh melt water is captured before it enters and mixes with the salt water of the ocean.

In some embodiments the fresh water is transported as ballast in tankers deadheading to home ports in the MENA.

In some embodiments fresh water is pumped or flows into the desert for irrigation purposes.

In some embodiments irrigated deserts sequester carbon dioxide.

An objective of this invention is to use carbon free, renewable energy sources to transport water into a desert

Another objective of this invention is to grow commercial products in the Earth's hot deserts.

Another objective of this invention is to convert the hot deserts to economically viable carbon sinks.

The novel features which are considered characteristic for the invention are set forth in the appended claims. The invention itself, however, both as to its construction and as to its method of operation, together with additional objects and advantages thereof, will be best understood from the following description of the specific embodiments when read and understood in connection with the accompanying drawings. Attention is called to the fact, however, that the drawings are illustrative only, and that changes may be made in the specific construction illustrated and described within the scope of the appended claims.

Other objects and advantages of the present invention will be apparent upon consideration of the following specification, with reference to the accompanying drawings in which like numerals correspond to like parts shown in the drawings.

### BRIEF DESCRIPTION OF THE DRAWINGS

FIG. 1 depicts the oceans and seas of the world.

FIG. 2 depicts the greenhouse effect.

FIG. 3 depicts the major ice caps and glaciers of the world.

FIG. 4 depicts the processes that are projected to induce global sea level rise.

FIG. 5 depicts the major hot deserts of the world.

FIG. 6 is a schematic of the Ocean Thermal Energy Conversion method.

FIG. 7 is a map of the world showing the regions of the ocean best suited to ocean thermal energy conversion.

FIG. 8 is a schematic of the ocean fresh water interface.

FIG. 9 depicts fresh water runoff from melting icecaps

FIG. 10 is a side view of a crude oil tanker.

FIG. 11 (a) is plan view of a crude oil tanker.

FIG. 11 (b) is a mid cross section of a crude oil tanker.

FIG. 12 is a schematic of a bladder for segregating oil and fresh water in the hold of an oil tanker for alternating trips to and from home ports.

FIG. 13 is a schematic of the electrolysis process

FIG. 14 is a view of a liquefied gas container

FIG. 15 is a schematic of the chimney effect

FIG. 16 is a schematic of hydrogen gas rising to an elevated point adjacent or in a desert.

FIG. 17 is a schematic of a fuel cell

FIG. 18 is a schematic of a hydrogen powered rotary engine.

FIG. 19 is a schematic of water flowing from an elevated source to a lower desert.

FIG. 20 depicts a typical center-pivot irrigation system.

FIG. 21 depicts the process of photosynthesis.

FIG. 22(a) is a representation of the Earth's land surface temperature variations and FIG. 22(b) is a representation of the Earth's corresponding vegetation.

### DESCRIPTION OF THE PREFERRED EMBODIMENT

In respect of the following and previously set out description and explanation, it should be understood that while the information given is considered to be correct, such explanations are necessarily somewhat speculative due to the complexity of natural systems and direct field measurement of carbon dioxide sequestration is difficult as tools currently employed are to varying degrees operationally and theoretically limited. Applicant would not want to be bound, therefore, by the following if, subsequently, new and better information becomes available. The explanations hereinafter given are made for the purpose of full and complete disclosure of the invention but the qualification given above should be borne in mind.

The following description generally relates to systems and methods for sequestering water and carbon dioxide in a desert environment. Such an environment may be treated to yield relatively high value commercial and sustaining food products.

The present invention significantly improves on the methodologies for sequestering carbon dioxide and provides a method of sequestering a portion of the water from glacial runoff believed to be caused by global warming that would otherwise contribute to sea level rise. It also converts to energy a portion of the heat being transferred to the world's oceans that would otherwise cause thermal expansion. It also converts a portion of the ocean's liquid volume to gas to reduce sea level rise and uses the hydrogen as both and energy as well as water currency.

In this specification the following terms shall have the following meanings. The term “albedo” shall mean the extent to which an object diffusely reflects light from the Sun. The term “equilibrium line altitude” shall mean the point above which, or poleward of which, snow and ice cover the ground throughout the year. The term “energy currency” shall mean a way of transporting energy from where it is produced to where it is needed. The term “evapotranspiration” shall mean the sum of evaporation and plant transpiration from the earth's land surface to the atmosphere. The term “faradaic efficiency” shall mean the efficiency with which charge (electrons) are transferred in a system facilitating an electrochemical reaction. The term “firn” shall mean partially compacted névé that has been left over from past seasons and has been recrystallized into a substance denser than névé, where névé is a young, granular type of snow which has been partially melted, refrozen and compacted. The term “glacial mass balance” shall mean the difference between accumulation and ablation (melting and sublimation) of a glacier. The term “ice-albedo feedback” shall mean the positive feedback mechanism whereby ice and snow reflect incoming short wave radiation from the sun causing the reflecting surface to cool, which in turn may cause more ice to form increasing the surface albedo even more. The term “planetary engineering” shall mean the application of technology for the purpose of influencing the global properties of a planet to make it habitable for life. The term “radiative forcing” shall mean the change in net irradiance at the tropopause. Where “Net irradiance” is the difference between the incoming radiation energy and the outgoing radiation energy in a given climate system and the tropopause is the boundary in the atmosphere between the troposphere and the stratosphere. Going upward from the surface, it is the point where air ceases to cool with height, and becomes almost completely dry. The term “thermal expansion” shall mean the tendency of matter to change in volume in response to a change in temperature. The term “water currency” shall mean a way of transporting hydrogen from where it is produced by electrolysis of water to where it is needed, there to be recombined with resident oxygen to produce water.

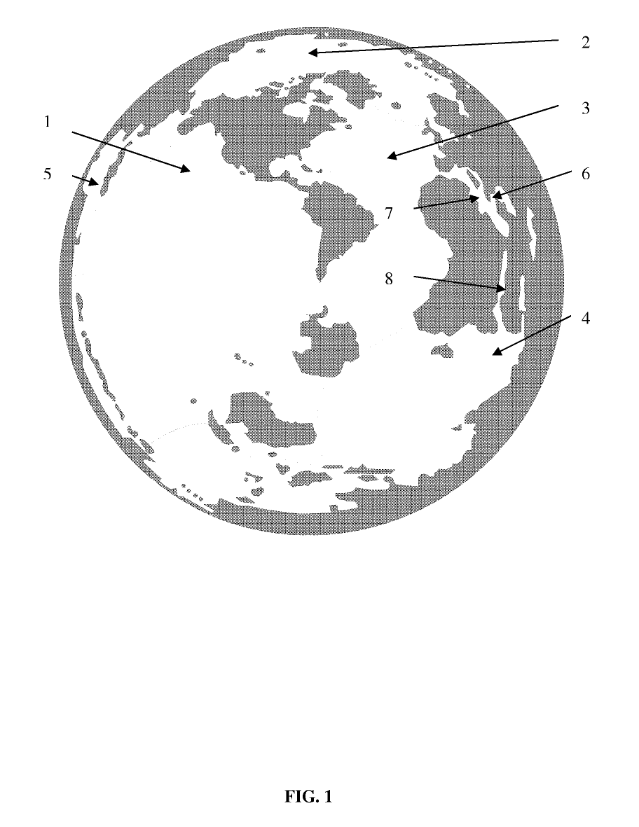

In FIG. 1 the oceans and seas of the world are depicted.

The Pacific Ocean 1, the Arctic Ocean 2, the Atlantic Ocean 3, the Indian Ocean 4, the South China Sea 5, the Black Sea 6 the Mediterranean Sea 7, and the Red Sea 8 cover approximately 71% of the Earth's surface, an area of approximately 361 million square kilometers.

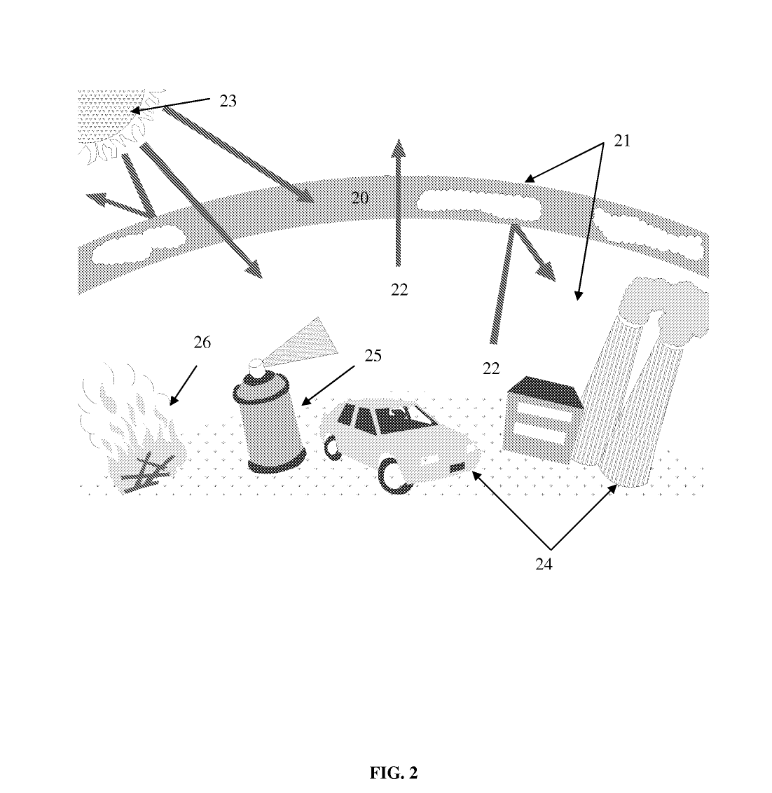

FIG. 2 depicts the greenhouse effect

In the 1980s scientists determined the average temperature of the Earth's surface was slowly rising. This trend is referred to as global warming. There has emerged a broad scientific consensus the cause of this rise is a build up of gases 20 in the atmosphere 21.

A greenhouse is a glass house in which plants grow which lets light in and at the same time keeps heat from getting out. This heat keeps the plants warm, even when it is cold outside.

It is believed the same thing is happening with the Earth's atmosphere 21. It lets sunlight 23 in and carbon dioxide and other gases 20 restrict this heat 22 from escaping into space.

Anthropogenic factors are human activities that change the environment. Various hypotheses for human-induced climate change have been argued for many years though, generally, the scientific debate has evolved from skepticism to a scientific consensus that human activity is the probable cause for the rapid changes in world climate in the past several decades. Consequently, the debate has largely shifted onto ways to reduce further human impact and to find ways to adapt to change that has already occurred.

Of most concern in these anthropogenic factors is the increase of carbon dioxide levels due to emissions from fossil fuel 24 combustion, followed by aerosols 25 (particulate matter in the atmosphere 21) and cement manufacture. Other factors, including land use, ozone depletion, animal agriculture and deforestation 26, are also of concern in the roles they play—both separately and in conjunction with other factors—in affecting climate change.

Human activities since the industrial revolution have increased the atmospheric concentration of various greenhouse gases 20, leading to increased radiative forcing from carbon dioxide, methane, tropospheric ozone, CFCs and nitrous oxide. The atmospheric concentrations of carbon dioxide and methane have increased by 36% and 148% respectively since the beginning of the industrial revolution in the mid-1700s. These levels are considerably higher than at any time during the last 650,000 years, the period for which reliable data has been extracted from ice cores. Less direct geological evidence indicates that carbon dioxide values this high were last seen approximately 20 million years ago. Fossil fuel 24 burning has produced approximately three-quarters of the increase in carbon dioxide from human activity over the past 20 years. Most of the rest is due to land-use change, in particular deforestation 26.

Carbon dioxide concentrations are expected to continue to rise due to ongoing burning of fossil fuels 24 and land-use change. The rate of rise will depend on uncertain economic, sociological, technological, and natural developments.

Beginning with the industrial revolution in the 19th Century and accelerating since, the human consumption of fossil fuels 24 has elevated carbon dioxide levels from a concentration of approximately 280 parts per million (ppm) in pre-industrial times to around 387 ppm today. The concentrations are increasing at a rate of about 2-3 ppm/year. If current rates of emission continue, these increasing concentrations are projected to reach a range of between 535 to 983 ppm by the end of the 21st century. Along with rising methane levels, it is suggested that these changes may cause an increase of 1.4-5.6° C. between 1990 and 2100 Proposals by some scientists and international coalitions, aimed at attempting to prevent drastic climate change, have suggested setting goals to try to limit concentrations of carbon dioxide to a range of 450 to 500 ppm.

One alternative hypothesis, widely refuted, to the consensus view that anthropogenic factors are causing temperature increase is that recent warming may be the result of variations in solar activity.

Models are used to help investigate the causes of recent climate change by comparing the observed changes to those that the models project from various natural and human-derived causes. Although these models do not unambiguously attribute the warming that occurred from approximately 1910 to 1945 to either natural variation or human effects, they do suggest that the warming since 1975 is dominated by man-made greenhouse gas emissions.

The Northern Hemisphere has more land than the Southern Hemisphere, so it warms faster. The Northern Hemisphere also has extensive areas of seasonal snow and sea-ice cover subject to the ice-albedo feedback. More greenhouse gases 20 are emitted in the Northern than Southern Hemisphere, but this does not contribute to a difference in warming between the north and south because the major greenhouse gases 20 persist long enough to mix between the hemispheres.

Some economists have tried to estimate the aggregate net economic costs of damages from climate change across the globe. Such estimates have so far yielded no conclusive findings; in a survey of 100 estimates, the values ran from US$-3 per tonne of carbon dioxide up to US$95 per tonne of carbon dioxide, with a mean of US$12 per tonne of carbon dioxide.

One widely publicized report on potential economic impact is the 2006 Stern Review. The report said the costs of acting to counter climate change, by stabilizing emissions of carbon dioxide in the atmosphere 21, might be about 1 percent of annual global gross domestic product (GDP) by 2050. But the cost of doing nothing was found to be far greater—risking up to 20 percent of the world's wealth. The report's methodology, advocacy and conclusions have been criticized by many economists, primarily around the Review's assumptions of discounting and its choices of scenarios. Others have supported the general attempt to quantify economic risk, even if not the specific numbers.

In a 2009 update Lord Stern revised his 2006 prediction, saying the cost of inaction would be “50 percent or more higher” than his previous highest estimate—meaning it could cost a third of the world's wealth.

The International Panel on Climate Change (IPCC) Working Group is responsible for crafting reports that deal with the mitigation of global warming and analyzing the costs and benefits of different approaches. The 2007 IPCC Fourth Assessment Report concluded that no one technology or sector can be completely responsible for mitigating future warming. They find there are key practices and technologies in various sectors, such as energy supply, transportation, industry, and agriculture that should be implemented to reduce global emissions. They estimate that stabilization of carbon dioxide equivalent between 445 and 710 ppm by 2030 will result in between a 0.6 percent increase and three percent decrease in global GDP.

According to the IPCC Working Group, to limit temperature rise to 2 degrees Celsius, developed countries as a group would need to reduce their emissions to below 1990 levels in 2020 (on the order of −10 percent to 40 percent below 1990 levels for most of the considered regimes) and to still lower levels by 2050 (80 percent to 95 percent below 1990 levels), even if developing countries make substantial reductions.

Human nature what it is, changing current energy regimes and reducing man's detrimental impacts on the environment will be difficult if not impossible to achieve. It is an objective of the current invention therefore to reduce the human impact of carbon dioxide on climate change, whether or not energy regimes are changed or other impacts are lessened. In one aspect of the current invention substantial amounts of the greenhouse gas carbon dioxide will be sequestered in vegetation planted in irrigated deserts.

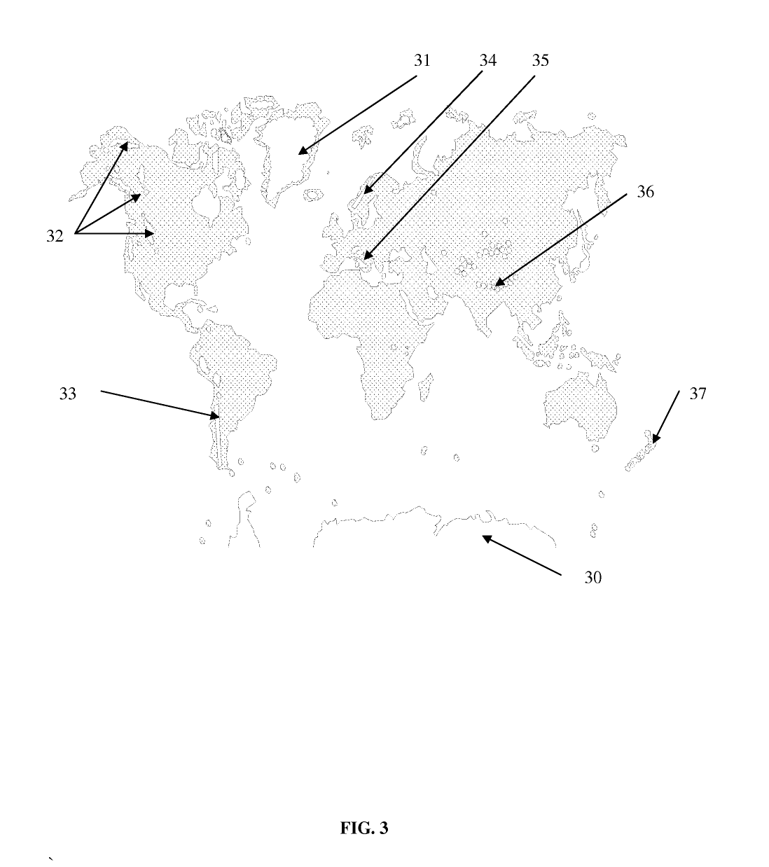

FIG. 3 depicts the major ice caps and glaciers of the world.

Glacial ice covers 10-11 percent of all land. The majority, almost 90 percent, of Earth's ice mass is in Antarctica 30, while the Greenland 31 ice cap contains 10 percent of the total global ice mass. Minor glaciers are found in North America 32 in the Arctic, and the Coastal and Rocky Mountain ranges. In South America 33 minor glaciers are found in the Andes while in Europe they are found in the Scandinavian countries 34 and the Alps 35. The Himalayan Mountains 36 and Southern Alps of New Zealand 37 comprise the remainder of the Earth's minor glaciers.

According to the National Snow and Ice Data Centre (NSIDC) in Boulder, Colo., if all glaciers melted today the seas would rise about 70 meters (m).

During the last ice age (when glaciers covered more land area than today) the sea level was about 122 m lower than it is today. At that time, glaciers covered almost one-third of the land.

During the last warm spell, 125,000 years ago, the seas were about 5.5 m higher than they are today. About three million years ago the seas could have been up to 50.3 m higher.

Sparse records indicate that glaciers have been retreating since the early 1800s. In the 1950s measurements began that allow the monitoring of glacial mass balance, reported to the World Glacier Monitoring Service (WGMS), Zurich, Switzerland, and the NSIDC. Although it is difficult to connect specific weather events to global warming, an increase in global temperatures may in turn cause broader changes, including glacial retreat, Arctic shrinkage, and worldwide sea level rise.

Glaciers around the globe continue to melt at high rates. Tentative figures for the year 2007, of the WGMS indicate a loss of average ice thickness of roughly 0.67 meter water equivalent (m.w.e.), where the standardized unit m.w.e. takes the different densities of change measurements in ice, fern and snow into account. One meter of ice thickness corresponds to about 0.9 m.w.e.

Some glaciers in the European Alps lost up to 2.5 m.w.e. The new still tentative data of more than 80 glaciers confirm the global trend of fast ice loss since 1980. Glaciers with long-term observation series (30 glaciers in 9 mountain ranges) have experienced a reduction in total thickness of more than 11 m.w.e. (12.2 metres) until 2007. The average annual ice loss during 1980-1999 was roughly 0.3 m.w.e. per year. Since 2000, this rate has increased to about 0.7 m.w.e. per year. The record loss during the two decades 1980-1999—0.7 metres in 1998—was exceeded in three of the six years between 2002 and 2007.

Table 1 is an estimate of the global distribution of water according to the Water resources, Encyclopedia of Climate and Weather, ed. by S. Schneider, Oxford University Press.

TABLE 1

| | | | Percent of |
|---|---|---|---|
| | Water volume, In | Percent of | total |
| Water source | cubic kilometres | total water | freshwater |
| Ice caps, Glaciers, & | 24,064,000 | 1.7% | 68.7% |
| Permanent Snow | | | |
| Total global | 35.030,000 | 2.5% | |
| freshwater | | | |
| Total global water | 1,386,000,000, | | |

Billions of people depend directly or indirectly on glaciers as natural water storage facilities for drinking water, agriculture, industry and power generation during key parts of the year.

It is an objective of the current invention to reduce the contribution carbon dioxide makes to glacier melting by sequestering a portion of this greenhouse gas in vegetation planted in irrigated portions of the world's deserts.

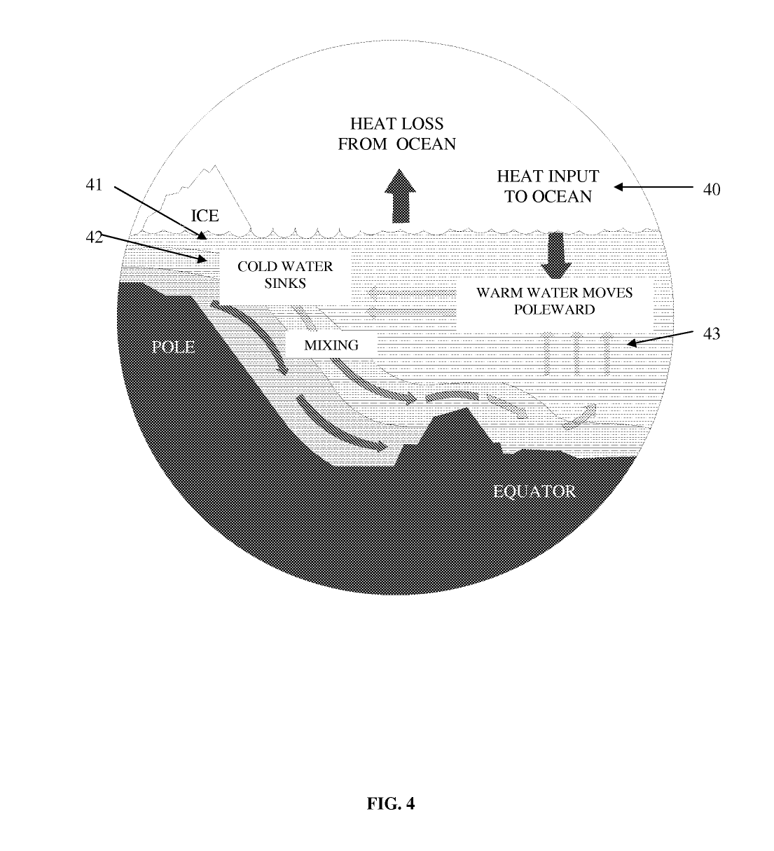

FIG. 4 depicts the processes that are projected to induce global sea level rise. Solar radiation 40 is absorbed by the oceans of the world and this heat 40 causes thermal expansion of the ocean water. The water melting from the glaciers and ice caps 41 of the world are causing additional sea level rise. The melting polar caps inject cold, heavy water 42 to the world's oceans, which sink and flow towards the equator where it is heated 43, rises and completes the cycle flowing back towards the poles.

Current sea level rise is occurring at a rate of around 1.8 mm per year for the past century, mainly it is widely believed as a result of human-induced global warming. This rate may be increasing. Measurements from the period 1993-2003 indicated a mean rate of 3.1 mm/year.

It is believed unmitigated global warming will continue to increase sea levels over at least the coming century. Increasing temperatures result in sea level rise by the thermal expansion of water and through the addition of water to the oceans from the melting of continental ice sheets.

There is no physical capacity of humans to protect against long-term sea level rise. Since greater than 75 percent of the human population lives within 60 km of a coast, it is important that sea level rise be limited to the greatest extent possible to minimize loss of life, and economic and ecological impacts.

Thermal expansion, which is well quantified, is currently the primary contributor to sea level rise and is expected to be the primary contributor over the course of the next century. Glacial contributions to sea level rise are believed to be less important, and are more difficult to predict and quantify.

Values for predicted sea level rise over the course of the next century typically range from 90 to 880 mm, with a central value of 480 mm. Based on an analog to the deglaciation of North America 9000 years ago, some scientists predict sea level rise of 1.3 m in this century. However, models of glacial flow in the smaller present-day ice sheets show that a probable maximum value for sea level rise in the next century is 800 mm, based on limitations on how quickly ice can flow below the equilibrium line altitude and to the sea.

For the purpose of this invention the 480 mm value or 0.48 m is used for comparative purposes.

A simple model to demonstrate sea level rise due to thermal expansion assumes that the ocean consists of two parts: the surface ocean and the deep ocean. The surface ocean is uniform in depth, temperature, and salinity. The depth of the surface ocean is 500 m. The average initial temperature of the upper ocean is 14° C. The deep ocean is everything else, and is assumed to not change.

The volume of water in the ocean is given by the equation: V=A*d, where A is the surface area of the ocean and d is the depth of the ocean. The mass of an object is equal to its volume multiplied by its density; m=V*ρ. Therefore d=m/(ρ*A). The problems is to find the changes in sea level Δd, which=d−d0, where d0 is the initial height of the ocean, 500 m.

Change in depth (sea level rise) is a function of density and the assumption for the purposes of this calculation is that the mass of the ocean and its surface area do not change. It is also assumed for the purposes of this calculation that the salinity of the ocean remains constant. The oceans density therefore is dependent solely on temperature. Since it has already been assumed the sea will rise by 0.48m over this century, this equates to a 4.4° C. increase in the temperature of the ocean, which is the increase in ocean temperature used in other calculations in this application

Sea level rise will change the amount and pattern of precipitation, likely including an expanse of the subtropical desert regions. Other likely effects include Arctic shrinkage and resulting Arctic methane release, shrinkage of the Amazon rainforest, increases in the intensity of extreme weather events, changes in agricultural yields, modifications of trade routes, glacier retreat, species extinctions and changes in the ranges of disease vectors.

Sea temperatures increase more slowly than those on land both because of the larger effective heat capacity of the oceans and because the ocean can lose heat by evaporation more readily than the land.

Glacial isostatic adjustment (GIA) is causing some coastal lands to sink, increasing the rate of sea level rise for those areas. In some areas of the world, GIA is causing land to rise allowing for some compensation to rising sea level.

A 2008 study by a group of U.S. scientists found that the economic damages from hurricanes has increased in the U.S. over time due to greater population, infrastructure, and wealth on the U.S. coastlines, and not to any spike in the number or intensity of hurricanes.

They found that although some decades were quieter and less damaging in the U.S. and others had more land-falling hurricanes and more damage, the economic costs of land-falling hurricanes has steadily increased over time.

A paper published in Natural Hazards Review, found that economic hurricane damage in the U.S. has been doubling every 10 to 15 years because more and more people continue to move to the hurricane-prone coastlines. The researchers for this paper used two different methods, which gave similar results, to estimate the economic damages of historical hurricanes if they were to strike today. The first method utilized population increases at the county coastal level, while the second used changes in housing units at the county coastal level. Both methods used changes in inflation and wealth at the national level.

The results of their study indicates that if the 1926 Great Miami Hurricane were to hit today, it would cause the a loss of between $140 billion to $157 billion, compared to Hurricane Katrina, causing the second most damage at $81 billion.

The team concluded that potential damage from storms—currently about $10 billion yearly—is growing at a rate that may place severe burdens on exposed communities, and that avoiding huge losses will require a change in the rate of population growth in coastal areas, major improvements in construction standards, or other mitigation actions.

There are two types of inundation that will be caused by sea level rise: permanent inundation and episodic inundation.

A higher sea level will provide a higher base for storm surges. A one-meter rise in sea level would enable a 15-year storm to flood areas that today are only flooded by 100-year storms. Flood damages would increase 36-58% for a 30-cm rise in sea level and increase 102-200% for sea level rise greater than 90 cm. Larger storms cause loss of beach width and force large sediments into inlets.

Although the frequency of hurricanes may not be increasing due to global warming it is clear rising sea levels will increase the damage they produce.

Rising sea levels would allow saltwater to penetrate farther inland and up streams. Higher salinity impairs both surface and groundwater supplies. This effect would impair water supplies, ecosystems, and coastal farmland. Saltwater intrusion would also harm aquatic plants and animals as well as threaten human water supply.

The penetration of saltwater can be compared to what occurs during extreme droughts when river runoff is diminished, forcing a fallow period in agriculture

In addition to damage to ecosystems, sea level rise promotes saltwater intrusion into coastal aquifers. A freshwater lens overlies saltwater along barrier coasts, and volcanic and coral islands. This freshwater lens is 40 times thicker than the elevation of the water table above mean sea level Therefore each increment of sea level rise reduces the freshwater capacity of the lens by 40 times.

In 2009 the Allianz Group, one of the world's largest financial services providers, estimated that sea level rise of 0.5 meters by 2050 would place 28 trillion US dollars worth of assets, in 136 global port mega-cities, at risk.

It is an objective of the current invention to limit the expected threat from sea level rise by generating power from a portion of the heat that would otherwise induce thermal expansion in the oceans and to sequester desalinated ocean water, which would otherwise inundate populated areas and produce other hazardous environmental effects, in the world's arid deserts.

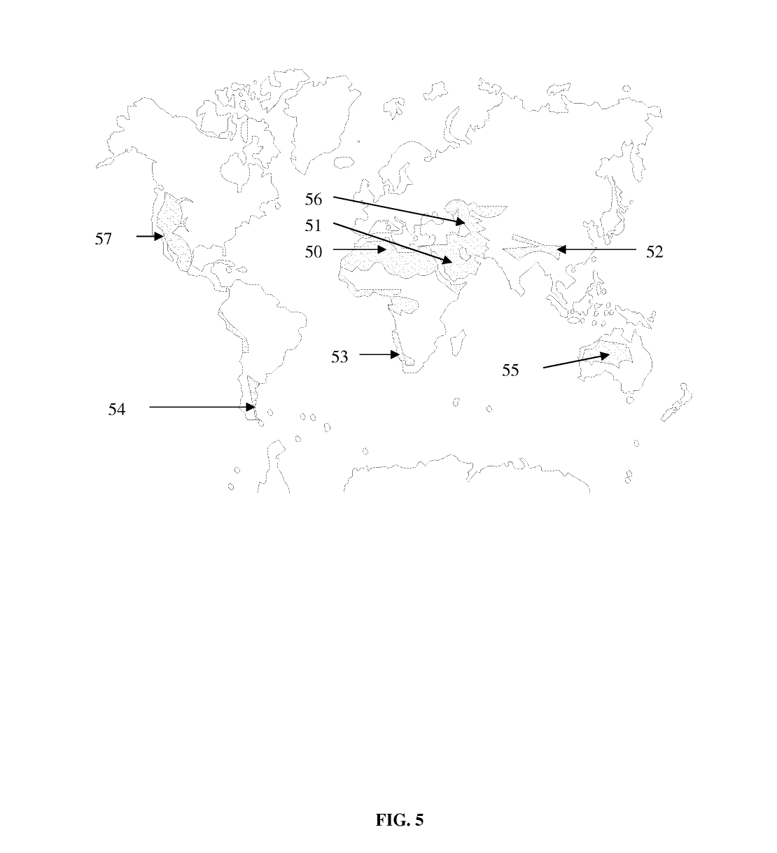

FIG. 5 depicts the major hot deserts of the world.

Deserts take up about one third of the Earth's land surface. One definition of a desert is an area that receives an average annual precipitation of less than 0.25 m or an area in which more water is lost to evaporation than falls as precipitation Hot deserts usually have a large diurnal and seasonal temperature range, with high daytime temperatures, and low night time temperatures (due to extremely low humidity). In hot deserts the temperature in the daytime can reach 45° C. or higher in the summer, and dip to 0° C. or lower in the winter. Water acts to trap infrared radiation from both the sun and the ground, and dry desert air is incapable of blocking sunlight during the day or trapping heat during the night. Thus, during daylight most of the sun's heat reaches the ground, and as soon as the sun sets the desert cools quickly by radiating its heat into space.

Table 2 shows the world's ten largest deserts.

TABLE 2

| Rank | Desert | Area (km²) | Cold | Hot | % of T |
|---|---|---|---|---|---|
| 1 | Antarctic Desert | 13,829,430 | 13,829,430 | | 32.10% |
| 2 | Arctic 2 | 13,700,000 | 13,700,000 | | 31.80% |
| 3 | Sahara (50) | 9,100,000 | | 9,100,000 | 21.12% |
| 4 | Arabian Desert (51) | 2,330,000 | | 2,330,000 | 5.41% |
| 5 | Gobi Desert (52) | 1,300,000 | | 1,300,000 | 3.02% |
| 6 | Kalahari Desert (53) | 900,000 | | 900,000 | 2.09% |
| 7 | Patagonian Desert (54) | 670,000 | | 670,000 | 1.55% |
| 8 | Great Victoria Desert (55) | 647,000 | | 647,000 | 1.50% |
| 9 | Syrian Desert (56) | 520,000 | | 520,000 | 1.21% |
| 10 | Great Basin Desert (57) | 92,000 | | 92,000 | 0.21% |
| Total | | 43,088,430 | 27,529,430 | 15,559,000 | 100.00% |

Many deserts are formed by rain shadows; mountains blocking the path of precipitation to the desert. Deserts are often composed of sand and rocky surfaces. Sand dunes called ergs and stony surfaces called hamada surfaces compose a minority of desert surfaces. Exposures of rocky terrain are typical, and reflect minimal soil development and sparseness of vegetation.

The ever worsening problems of environmental degradation, combined with increasing population makes action imperative to restore deserts to productive use. Agroforestry, irrigated agriculture, mixed species grazing, agri-tourism and other techniques can be used to increase yields and speed recovery. These approaches must also be sustainable.

The largest of the world's hot deserts is the Sahara 50 which was once verdant but turned to desert over thousands of years rather than in an abrupt shift as was previously believed.

Understanding this process is helpful in predicting future climate change.

There are also signs of a small shift back towards greener conditions in parts of the Sahara 50, apparently because of global warming.

A study of ancient pollen, spores and aquatic organisms in sediments in Lake Yoa in northern Chad showed the region gradually shifted from savannah 6,000 years ago towards the arid conditions that took over about 2,700 years ago.

The findings, about one of the biggest environmental shifts of the past 10,000 years, challenge past belief based on evidence in marine sediments that a far quicker change created the world's biggest hot desert.

Scientists, studying the remote 3.5 sq km Lake Yoa, found the region had once had grasses and scattered acacia trees, ferns and herbs. The salty lake is renewed by groundwater welling up from beneath the desert.

A gradual drying, blamed on shifts in monsoon rains linked to shifts in the power of the sun, meant large amounts of dust started blowing in the region about 4,300 years ago. The Sahara 50 now covers an area the size of the United States.

This improved understanding of the formation of the Sahara 50 might help climate modelers improve forecasts of what is in store from global warming. Some areas will apparently be more vulnerable to drought, others to more storms or floods.

The Sahara 50 got greener when temperatures rose around the end of the Ice Age about 12,000 years ago. Warmer air can absorb more moisture from the oceans and it fell as rain far inland. There are indications this process may be slowly repeating as current temperatures rise. Tens of kilometres of unoccupied desert are now covered by grass where for a long time there was nothing but sand.

Poor regions, particularly Africa, appear at greatest risk from the projected effects of global warming, while their carbon emissions have been small compared to the developed world. At the same time, developing country exemptions from provisions of the Kyoto Protocol have been criticized by the United States and Australia, and were used as part of a rationale for non-ratification by the U.S.

Developing countries dependent upon agriculture will be particularly harmed by global warming.

The issue of climate change has sparked debate weighing the benefits of limiting industrial emissions of greenhouse gases against the costs that such changes will entail.

There has been discussion in several countries about the cost and benefits of adopting alternative energy sources in order to reduce carbon emissions. Business-centered organizations, conservative commentators, and large petroleum companies have downplayed IPCC climate change scenarios. They have also funded scientists who disagree with the scientific consensus, and provided their own projections of the economic cost of stricter controls. Likewise, environmental organizations and a number of public figures have emphasized the potential risks of climate change and promote the implementation of GHG emissions reduction measures.

Some fossil fuel companies have scaled back their efforts in recent years, or have called for policies to reduce global warming.

Another point of contention is the degree to which emerging economies such as India and China should be expected to constrain their emissions. According to recent reports, China's gross national carbon dioxide emissions may now exceed those of the U.S. China has contended that it has less of an obligation to reduce emissions since its per capita emissions are roughly one-fifth that of the United States. India, also exempt from Kyoto restrictions and another of the biggest sources of industrial emissions, has made similar assertions. The U.S. contends that if it must bear the cost of reducing emissions, then China must as well.

Some and semi-arid lands can support crops, but additional pressure from greater populations or decreases in rainfall can lead to the few plants present disappearing. The soil becomes exposed to wind, causing soil particles to be deposited elsewhere. The top layer becomes eroded. With the removal of shade, rates of evaporation increase and salts become drawn up to the surface. This increases soil salinity and inhibits plant growth. The loss of plants causes less moisture to be retained in the area, which may change the climate pattern leading to lower rainfall.

A number of methods have been tried in order to reduce the rate of desertification and regain lost land; however, most measures treat symptoms of sand movement and do not address the root causes of land modification such as overgrazing, unsustainable farming (eg cattle fanning) and deforestation by the indigenous population. In developing countries under threat of desertification, many local people use trees for firewood and cooking, which has increased the problem of land degradation and often even increased their poverty. In order to gain further supplies of fuel the local population add more pressure to the depleted forests; adding to the desertification process.

Techniques to counter desertification focus on two aspects: provisioning of water (eg by wells and energy intensive systems involving water pipes over long distances) and fixating and hyper-fertilizing soil.

Fixating the soil is often done through the use of shelter belts, woodlots and windbreaks. Windbreaks are made from trees and bushes and are used to reduce soil erosion and evapotranspiration.

The enriching of the soil and the restoration of its fertility is often done by a variety of plants. Of these, the Leguminous plants which extracts nitrogen from the air and fixes it in the soil, and food crops/trees as grains, barley, beans and dates are the most important.

Africa, with coordination from Senegal, has launched its own “green wall” project. Trees will be planted on a 15 km wide land strip from Senegal to Djibouti. Aside from countering desert progression, the project is also aimed at creating new economic activities, especially thanks to tree products such as gum arabic

More efficient use of existing water resources and control of salinization are other tools for mitigating arid lands. New ways are also being sought to find groundwater resources and to develop more effective ways of irrigating arid and semiarid lands. Research on the reclamation of deserts is also focusing on discovering proper crop rotation to protect fragile soil, on understanding how sand-fixing plants can be adapted to local environments, and on how overgrazing can be addressed.

A recent development is the Seawater Greenhouse and Seawater Forest. This proposal is to construct these devices on coastal deserts in order to create freshwater and grow food.

The Sahara Forest project will use seawater and solar power to grow food in greenhouses across the desert. Vast greenhouses that use seawater to grow crops could be combined with solar power plants to provide food, fresh water and clean energy in deserts, under an ambitious proposal from a team of architects and engineers.

The Sahara Forest project would marry huge greenhouses with concentrated solar power (CSP), which uses mirrors to focus the sun's rays and generate heat and electricity. The installations would turn deserts into lush patches of vegetation, according to its designers, and without the need to dig wells for fresh water, which has depleted acquifers in many parts of the world.

The current art is however unproven and of limited applicability, since sites must be chosen that are below sea level.

It is an objective of the current invention to provide a widely applicable and sustainable way of turning the Earth's hot deserts into lush vegetation.

It is another objective of the current invention to create a method of mitigating the effects of global warming that are economically conducive to implementation.

As explained above the area of the Earth's surface covered by the oceans is 361 million square kilometres. Furthermore it is assumed for the purposes of this invention that if the status quo is maintained sea levels will rise 480 mm (0.00048 km) over the coming century. In order to maintain current sea levels, it would be necessary therefore for the purposes of the current invention (using this aspect alone) to sequester 173,280 km³ (361,000,000 km²×0.00048 km) of desalinated water in the world's hot deserts. As shown in Table 2 the hot deserts cover an area of 15,559,000 km². Therefore 0.0111 km or 173,280 km³/15,559,000 km² of water will have to be taken up by the deserts the next hundred years or 0.111 m of water every year.

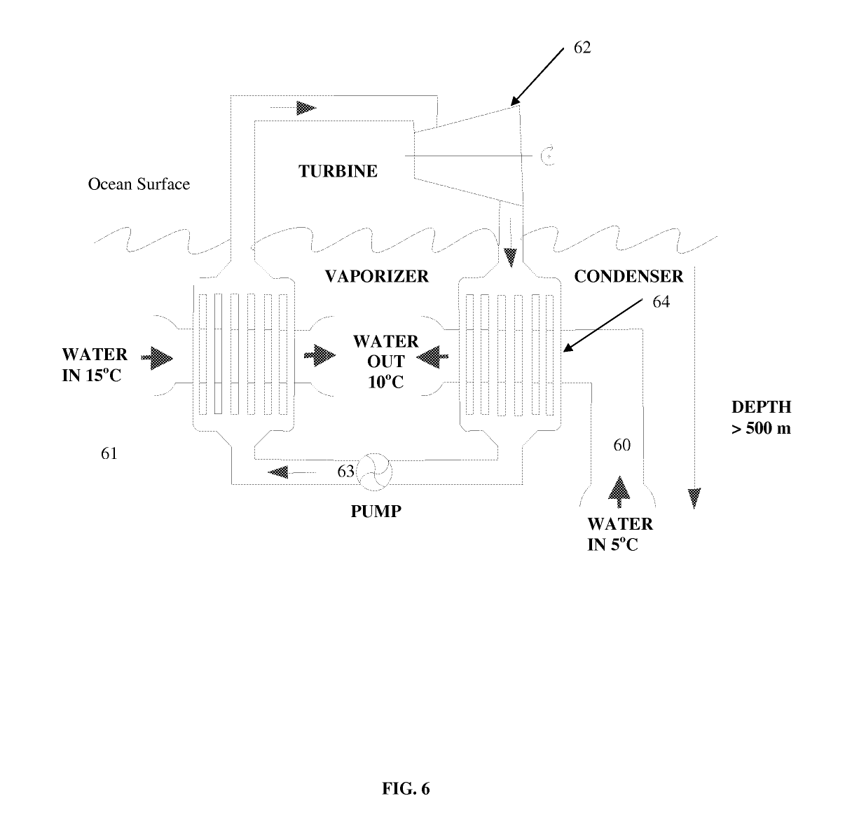

FIG. 6 is a schematic of the Ocean Thermal Energy Conversion method.

The Earth is hit with 165,000 terawatts (TW) of solar power every moment of every day. The ocean absorbs part of this energy causing thermal expansion and sea level rise. Effectively the world's oceans are acting like thermal batteries that are overcharging storing a potential to seriously harm low lying coastal regions and their inhabitants.

A recent Nature article, “Robust warming of the global upper ocean” points out that the average amount of energy the ocean has absorbed over the period 1993 to 2008 is enough to power nearly 500 100-watt light bulbs for each of the roughly 6.7 billion people on the planet. This amounts to 330 TW whereas the total annual world energy consumption in 2006 for all primary energy sources was only 15.8 TW.

As Charles H. Greene Director, Ocean Resources and Ecosystems Program, Department of Earth and Atmospheric Sciences, Cornell University, and others recently noted in a paper, A Very Inconvenient Truth, due to the ocean's thermal inertia this build up of energy in the ocean makes atmospheric warming essentially irreversible for the next thousand years even if we immediately stopped adding carbon dioxide to the atmosphere.

The First law of thermodynamics dictates that, “the increase in the internal energy of a system is equal to the amount of energy added by heating the system minus the amount lost as a result of the work done by the system on its surroundings.”

The way therefore to dissipate some of the heat the oceans have and are absorbing is to covert this energy to work as would be accomplished by producing electrical energy by the process of ocean thermal energy conversion (OTEC).

To give 10 billion people, as is the projected population by the year 2150, the level of energy prosperity the developed world is used to, a couple of kilowatt-hours per person, an additional 60 TW of power needs to be generated around the planet. The overcharging oceans are an available source of this projected energy shortfall.

OTEC is a method for generating electricity, which uses the temperature difference that exists between deep ocean water 60, typically at 5° C. and shallow ocean waters 61, typically about 15° C., but as high as 24° C. in equatorial regions, where the largest deserts are found, to run a heat engine 62. The working fluid of the system is a low-boiling-point fluid such as ammonia 63 or 1,1,1,2-Tetrafluoroethane, which is vaporized by the warm water 61, with the vapour driving the heat engine 62, which in turn drives a dynamo to produce electrical energy and the cold deep water 60 then condenses the exhausted low-boiling-point fluid 63 in a condenser 64.

One aspect of the current invention would generate power using OTEC. The current invention uses the OTEC process to extract a portion of heat from the ocean that would otherwise induce thermal expansion of the ocean leading to sea level rise.

The idea for OTEC dates back to 1881 when the French Engineer, Jacques D'Arsonval first conceived of generating power utilizing the temperature differential between warm surface water 61 and colder waters 60 from the deep.

As with any heat engine, the greatest efficiency and power is produced with the largest temperature difference. OTEC works best when the temperature difference between the warmer, top layer of the ocean and the colder, deep ocean water 60 is about 20° C. These conditions exist in tropical coastal areas, roughly between the Tropic of Capricorn and the Tropic of Cancer where the hot deserts of the world are located.

Open cycle and hybrid cycle OTEC systems can also produce large quantities desalinated water concurrent to generating power.

Even though there has been an awareness of the greenhouse gas problem for decades and the United Nations Framework Convention on Climate Change, which is an international environmental treaty produced at the 1992 Earth Summit, held in Rio de Janeiro, was aimed at stabilizing greenhouse gas concentrations in the atmosphere at a level that would prevent dangerous anthropogenic interference with the climate system, greenhouse gas concentrations have continued to climb since the treaty was produced.

Some scientists do not believe mankind will be able to keep carbon levels low enough to prevent catastrophe and therefore are considering geo-engineering techniques on a massive scale to tinker with the environment to correct the problem.

Extracting heat from the ocean that would otherwise cause sea level rise is a viable planetary engineering technique that would mitigate one of the major problems expected to result from global warming with the added benefit of producing significant amounts of valuable, energy.

The technology for producing energy by the process of OTEC is well known in the industry and does not form a part of this inventive concept. It is an objective of the current invention however to use OTEC to extract a portion of heat from the oceans that would otherwise induce thermal expansion and sea level rise.

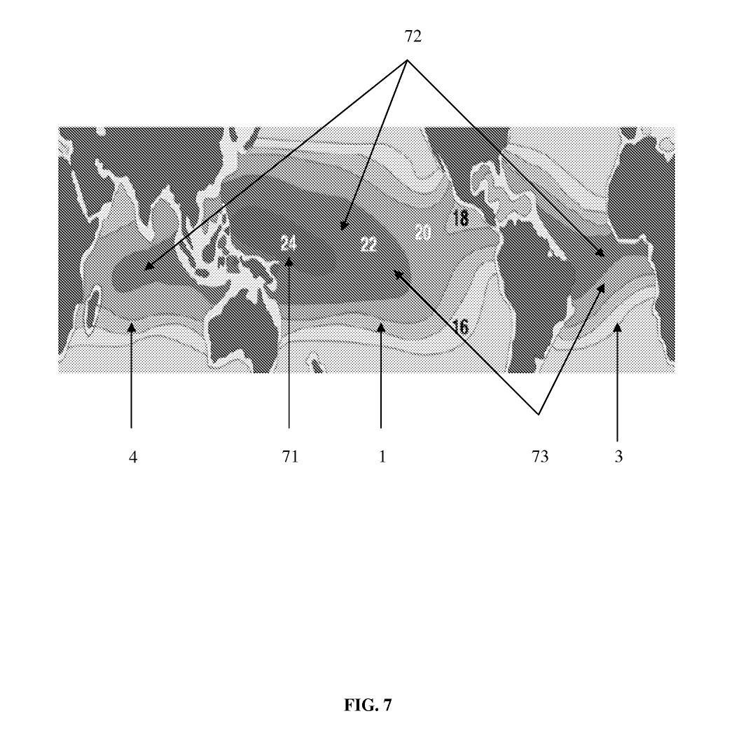

FIG. 7 is a map of the world showing the regions of the ocean best suited to ocean thermal energy conversion.

As explained above the greatest efficiency and power for OTEC conversion is derived where the greatest temperature differences exist between the surface temperature and the deep ocean water 60. FIG. 7 shows the warmest ocean surface waters 61 are 24° C. in the Pacific Ocean 1 west of Indonesia and the Philippines 71. Surface temperatures in the range of 22° C. 72 are found in the equatorial regions of the Eastern Pacific, the Atlantic 3 and the Indian Oceans 4. And temperatures of 20° C. 73 are found in the Western Pacific and more northerly and southerly reaches of the Atlantic 3.

Estimates of the amount of electricity OTEC could sustainably generate are between 3 and 10 terawatts or up to five times the amount of electricity the world currently uses.

One of the major drawbacks of producing electricity using OTEC is the bulk of this power would be produced a considerable distances from shore

The two options for getting OTEC power to shore are submarine electrical cables or the production of energy intensive products such as ammonia, hydrogen or aluminium which could subsequently be transported to markets on shore.

Typical costs for under-sea electrical cables are 3 times higher than High Voltage Direct Current cables used on land and making a fixed cable connection between an OTEC platform bobbing in the ocean and stationary transmission lines on shore present further difficulties.

One way to capture the energy potential of the bulk of the electricity produced offshore is to produce valuable and energy-intensive products such as ammonia. Ammonias production for fertilizer (made from fossil fuels using the Haber-Bosch process) currently consumes about 2 percent of the world's energy use and accounts for a sizeable chunk of global CO2 emissions. Ammonia can also be burned as a fuel or used as a way of ferrying hydrogen around (each ammonia molecule contains three hydrogen atoms), which can be released and used as a fuel as well.

Another way of capturing stranded OTEC electrical energy is in the form of the energy currency hydrogen (H.SUB.2), which can be produced by disassociating water into its component gases H.SUB.2 and oxygen (O.SUB.2) by the process of electrolysis.

Producing H.SUB.2 by electrolysis would reduce the velocity of sea level rise by converting a portion of the ocean's liquid volume to gas only 1/9th of which by weight, compared to the volume of water converted, would have to be transported to shore where it could be recombined with resident O.SUB.2 to produce both energy as well as water.

An objective of the current invention is provide an economic means of transporting energy created in regions of the ocean best suited to producing OTEC power to where the energy is needed by converting OTEC produced electricity to the energy currency H.SUB.2.

Another objective of the current invention is to reduce the rate of sea level rise by converting a portion of the oceans liquid volume to its constituent gases H.SUB.2 and O.SUB.2.

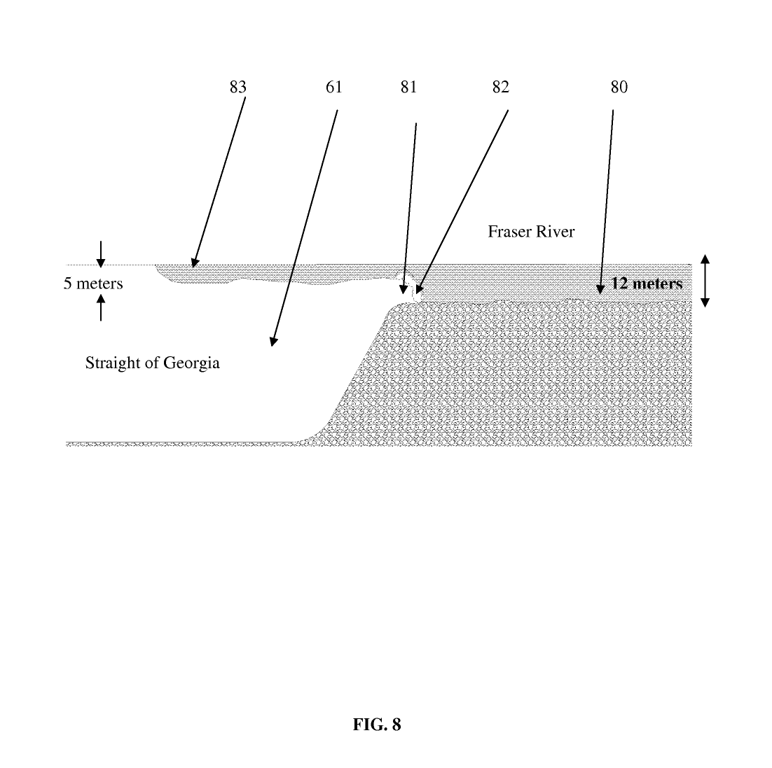

FIG. 8 is a schematic of the ocean fresh water interface.

When fresh river water 80 meets shallow ocean waters 61, the lighter fresh water 80 rises up and over the denser ocean water 61. Ocean water 61 noses into the estuary 81 beneath the out flowing river water 80, pushing its way upstream along the bottom. The difference in density between fresh 80 and ocean water 61 creates a surface tension that temporarily postpones the mingling of the two.

Eventually however these waters mix at which point the fresh water 80 that has entered the ocean will no longer be suited for either human consumption or irrigation purposes.

Often, as in the Fraser River of British Columbia, this interface between fresh river water 80 and ocean water 61 occurs at an abrupt salt front 82. Across such a front 82, the salt content (salinity) and density may change from oceanic to fresh in just a few tens of meters horizontally and as little as a meter vertically.

As shown in FIG. 8 the fresh water 80 may flow above the ocean water 61 for a number of kilometres seaward without mixing. This fresh river water 83 flow may be as deep 5 meters.

It is an objective of the current invention to harvest some of the fresh water 80 at the mouth of the world's major rivers before they mix with salt water and to use this fresh water 80 to irrigate portions of the world's hot deserts.

Rivers in some of the world's most populous regions are losing water, according to a May 2009 comprehensive study of global stream flow by scientists at the National

Center for Atmospheric Research. The study suggests in many cases the reduced flows are associated with climate change and could potentially threaten future supplies of food and water.

An examination of stream flows from 1948 to 2004, found significant changes in about one-third of the world's largest rivers. Of those, rivers with decreased flow outnumbered those with increased flow by a ratio of about 2.5 to 1.

Several of the rivers channeling less water serve large populations, including the Yellow River in northern China, the Ganges in India, the Niger in West Africa, and the Colorado in the south-western United States. In contrast, the scientists reported greater stream flow over sparsely populated areas near the Arctic Ocean 2, where snow and ice are rapidly melting.

It is believed reduced river runoff is increasing the pressure on freshwater resources in much of the world, especially with more demand for water as population increases.

Many factors can affect river discharge, including dams and the diversion of water for agriculture and industry but researchers believe that the in many cases reduced flows are related to global climate change, which is altering precipitation patterns and increasing the rate of evaporation.

Discharge from the world's great rivers results in deposits of dissolved nutrients and minerals into the oceans. The freshwater flow also affects thermohaline circulation patterns, which are driven by changes in salinity and temperature and which play a vital role in regulating the world's climate.

The study found that, from 1948 to 2004, annual freshwater discharge into the Pacific Ocean fell by about 6%, or 526 cubic kilometres—approximately the same volume of water that flows out of the Mississippi River each year. The annual flow into the Indian Ocean 4 dropped by about 3%, or 140 cubic kilometres. In contrast, annual river discharge into the Arctic Ocean 2 rose about 10%, or 460 cubic kilometres.

In the United States, the Columbia River's flow declined by about 14% during the 1948-2004 study period, largely because of reduced precipitation and higher water usage in the West. The Mississippi River, however, has increased by 22% over the same period because of greater precipitation across the Midwest since 1948.

Some rivers, such as the Brahmaputra in South Asia and the Yangtze in China, have shown stable or increasing flows. But they could lose volume in future decades with the gradual disappearance of the Himalayan glaciers feeding them.

Table 3 is a list of world's major rivers by average discharge

TABLE 3

| | | | | | Average | |
|---|---|---|---|---|---|---|
| | | Length | Length | Drainage area | discharge | |
| Continent | River | (km) | (miles) | (km²) | (m³/s) | Outflow |
| S America | Amazon | 6,387 | 3,969 | 6,915,000 | 219,000 | Atlantic |
| Africa | Congo | 4,371 | 2,716 | 3,680,000 | 41,800 | Atlantic |
| Asia | Ganges - | 2,948 | 1,832 | 1,500,000 | 33,470 | Bay of Bengal |
| | brahmaputra | | | | | |
| S America | Orinoco | 2,140 | 1,330 | 880,000 | 31,900 | Atlantic |
| Asia | Yangtze | 6,380 | 3,964 | 1,800,000 | 31,900 | E China Sea |
| S America | Rio Nego | 2,230 | 1,390 | 691,000 | 29,300 | Atlantic |
| S America | Paraná | 3,998 | 2,484 | 3,100,000 | 25,700 | Atlantic |
| Asia | Yenisei | 5,550 | 3,449 | 2,580,000 | 19,600 | Kara Sea |
| Asia | Lena | 4,260 | 2,647 | 2,490,000 | 17,100 | Laptev Sea |
| S America | Madeira- | 3,239 | 2,013 | 850,000 | 17,000 | Amazon |
| | Mamoré | | | | | |
| N America | Mississippi - | 6,270 | 3,896 | 2,980,000 | 16,200 | Gulf of |
| | Missouri | | | | | Mexico |
| Asia | Mekong | 4,023 | 2,500 | 810,000 | 16,000 | South China Sea |
| Asia | Pearl - Xi | 2,200 | 1,376 | 437,000 | 13,600 | South China Sea |
| | Jiang | | | | | |
| S America | Tocantins | 2,699 | 1,677 | 1,400,000 | 13,598 | Atlantic |
| | | | | | | Ocean, |
| | | | | | | Amazon |
| Asia | Ayeyarwady | 2,170 | 1,348 | 411,000 | 13,000 | Andaman Sea |
| Asia | Ob′ - Irtysh | 5,410 | 3,449 | 2,990,000 | 12,800 | Gulf of Ob |
| Asia | Amur | 4,352 | 2,714 | 1,855,000 | 11,400 | Sea of |
| | | | | | | Okhotsk |
| S America | Caroní | 951 | 595 | 95,000 | 10,850 | Orinoco river |
| N America | Mackenzie - | 4,241 | 2,635 | 1,790,000 | 10,300 | Beaufort Sea |
| | Peace | | | | | |
| N America | Saint | 3,058 | 1,900 | 1,030,000 | 10,100 | Gulf of Saint |
| | Lawrence - | | | | | Lawrence |
| | Great Lakes | | | | | |
| Africa | Niger | 4,167 | 2,589 | 2,090,000 | 9,570 | Atlantic |
| | | | | | | Ocean |
| Europe | Volga | 3,692 | 2,294 | 1,380,000 | 8,060 | Caspian Sea |
| Asia | Sepik | 1,126 | 700 | 80,321 | 8,000 | Bismarck Sea |
| North | Columbia | 2,000 | 1,243 | 668,000 | 7,500 | Pacific Ocean |
| America | | | | | | |
| Europe | Danube | 2,860 | 1,777 | 817,000 | 7,130 | Black Sea |
| Europe | Pechora | 1,809 | 1,124 | 289,532 | 3,949 | Barents Sea |
| North | Fraser River | 1,375 | 854 | 220,000 | 3,475 | Pacific Ocean |
| America | | | | | | |
| Europe | Northern | 744 | 462 | 357,052 | 3,332 | White Sea |
| | Dvina River | | | | | |
| Africa | Nile River | 6,650 | 4,132 | 3,400,000 | 2,830 | Mediterranean |
| Europe | Rhine | 1,320 | 820 | 170,002 | 2,290 | North Sea |
| Europe | Douro | 927 | 576 | 97,682 | 714 | Atlantic |
| | | | | | | Ocean |
| Europe | Okavango | 1,600 | 1,000 | 530,000 | 475 | Okavango |
| | River | | | | | Delta |
| Europe | Tagus | 1087 | 675 | 80,600 | 444 | Atlantic |
| | | | | | | Ocean |
| Europe | Ebro | 910 | 565 | 80,093 | 426 | Mediterranean |
| Europe | Minho | 300 | 186 | 17,081 | 380 | Atlantic |
| Africa | Sebou River | 458 | 284 | 40,000 | 137 | Atlantic |
| Europe | Guadiana | 829 | 516 | 66,800 | 85 | Atlantic |
| Europe | River Thames | 346 | 215 | 12,935 | 65.8 | North Sea |

| | |
|---|---|
| Total Discharge (m³/s) | 653,481 |

The total discharge from these rivers is 20,608 km3/year and considering the world's oceans cover an area of 361 million square kilometres this annual discharge raises their levels 0.06 metres per year. This is about half the projected annual amount of sea level rise over the next 100 years.

A 1997 study by the Quebec government found that seawater made drinkable by desalination plants remains two to three times cheaper than fresh water transported by tanker. Future water shortages may alter this dynamic, as does the potential of the world's hot deserts to sequester substantially quantities of carbon dioxide.

According to a recent forum of the World Water Council, in The Hague, 1.4 seven million a year die from diseases linked to unsanitary water. The problem is getting worse: an estimated 20 percent more water than is now available will be needed to supply the needs of the three billion additional human beings who will be alive by 2025. Transported fresh water may be the only way to satisfy this need.

It is an objective therefore of the current invention to harvest a portion of the world's fresh water 80 flowing into the oceans before it becomes contaminated with salt and contributes to sea level rises. This fresh, river water 83 may be used to promote photosynthesis in the world's hot deserts by irrigating portions of said deserts and some may supply the needs of the additional three billion human beings who will be alive by 2025.

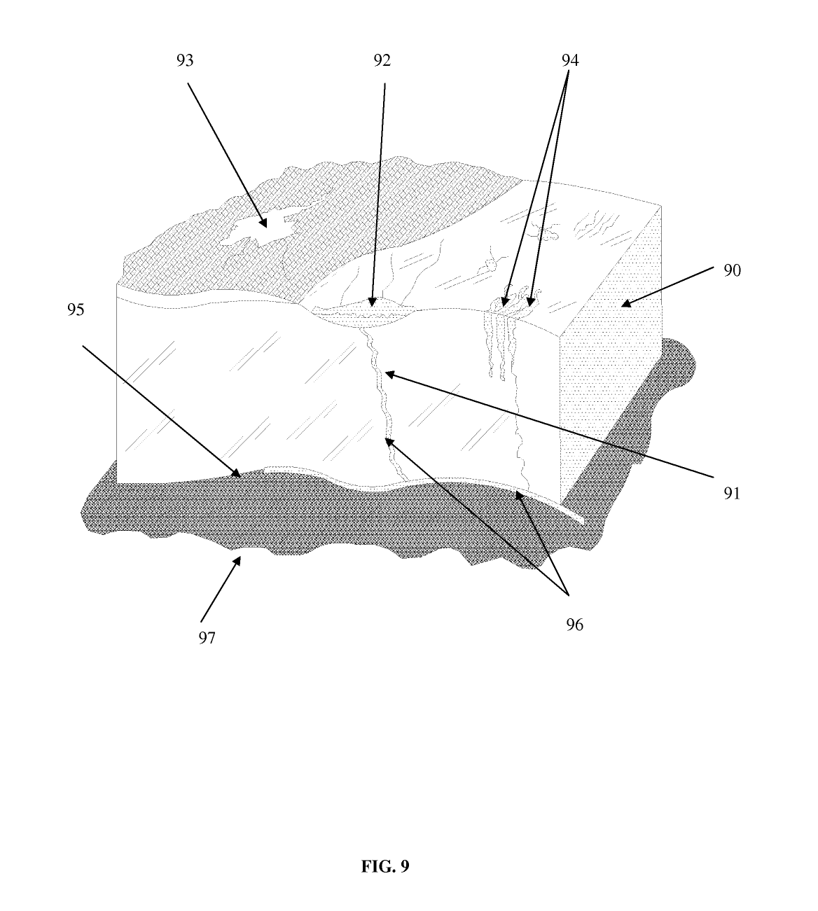

FIG. 9 depicts fresh water runoff from melting icecaps

As explained above glaciers around the globe continue to melt at high rates. Snow and sea ice reflect from 85 to 90% of the sun's rays striking the earth, while dark surfaces such as water and land reflect only 10-20%. This reflectance is particularly important in the circumpolar regions where the atmosphere is thinner and the potential for a greater number of the sun's rays to hit the earth and is the primary reason the polar areas of the globe are feeling the effects of global warming the most.

Another factor in increasing rates of glacial ice melt is atmospheric pollution. Most fossil fuels are not clean burning and small particles of soot rise high up into the atmosphere. Much of this pollution lands on polar ice, which makes the ice darker in color, reducing the albedo effect. The sun's rays are absorbed by this darker coloured ice, which heats the ice up causing it to melt.

Glaciers 90 are thick packs of snow and ice that are found in polar and alpine regions of the world. They are made up of ice that is very old. Generally when glacial ice melts, it is the newest ice that melts first. “Old ice” is ice that is greater than six years old, and can be 12 to 15 feet thick. In recent years, the NSIDC reports that whereas old ice has previously made up about 20% of all glaciers, it now comprises only 6% because of increased melting. Melting glaciers 90 are particularly important in Alaska where approximately half of glacial melt worldwide has occurred. Glaciers in Alaska are responsible for nearly 10% of the sea level rise that has occurred in oceans to date.

The Greenland Ice Sheet is also melting faster than previously calculated according to a scientific paper by University of Alaska Fairbanks.

The study is based on the results of state-of-the-art modeling using data from the Intergovernmental Panel on Climate Change as well as satellite images and observations from on the ground in Greenland 31.

The total amount of Greenland Ice Sheet freshwater input into the North Atlantic Ocean expected from 2071 to 2100 will be more than double what is currently observed. The current East Greenland Ice Sheet freshwater flux is 257 km3 per year from both runoff and iceberg calving. This freshwater flux is estimated to reach 456 km3 by 2100.

Some scientists have cautioned that current projections are overly optimistic as they assume a linear, rather than erratic, progression. James Hansen has argued that multiple positive feedbacks could lead to nonlinear ice sheet disintegration much faster than claimed by the IPCC. According to a 2007 paper, “we find no evidence of millennial lags between forcing and ice sheet response in paleoclimate data. An ice sheet response time of centuries seems probable, and we cannot rule out large changes on decadal time-scales once wide-scale surface melt is underway”

As shown in FIG. 9 a Moulin 91 is a narrow, tubular chute, hole or crevasse through which water enters a glacier from the surface 92 of the glacier 90.

Moulins 91 can be up to 10 meters wide and are typically found at a flat area of a glacier 93 in a region of transverse crevasses 94. Moulins 91 can go all the way to the bottom of the glacier 95 and can be hundreds of meters deep, or may reach the depth of common crevasse 94 formation (about 10-40 m) where the stream flows englacially.

Moulins 91 are a part of a glacier's internal “plumbing” system that carries melt water 96 from the surface 92 down to wherever it may go. Water 96 from moulins 91 often exits the glacier 90 at base level 95, sometimes into the sea, and occasionally the lower end of a moulin may be exposed in the face of a glacier 90 or at the edge of a stagnant block of ice.

Water from moulins 91 may help lubricate the base of the glacier 95, affecting glacial motion. Given an appropriate relationship between an ice sheet and the terrain 97, the head of water in a moulin 91 can provide the power and medium with which a tunnel valley may be formed. The role of water in lubricating the base of ice sheets and glaciers 90 is complex. Difficulties modelling this process lead to apparently over optimistic predictions of sea level rise by the IPCC in the IPCC fourth assessment report. Recent research by Stefan Rahmstorf, released at the Climate Congress suggests that sea level rise will be greater than predicted in the IPCC's report.

The melt zone, where summer warmth turns snow and ice into slush and melt ponds of melt water 96, has been expanding at an accelerating rate in recent years. When the melt water 96 seeps down through cracks in the sheet, it accelerates the melting and, in some areas, allows the ice to slide more easily over the bedrock below, speeding its movement to the sea. Besides contributing to global sea level rise, the process adds freshwater to the ocean, which may disturb thermohaline circulation and thus regional climate.

Antarctica 30 accounts for about 90% of the world's ice and Greenland 31 close to 10% but because Greenland 31 is closer to the equator than Antarctica 30, the temperatures there are higher and Greenland ice is more likely to be the first to melt. If Greenland's ice were to melt in total it would add 7 meters to the sea levels.

Arctic Ocean 2 ice is not nearly as thick as at the South Pole and this ice is floating thus when melted it would have little effect on sea level rise. It also would melt directly into the ocean and accordingly would be difficult to harvest before mixing.

It is an objective of the current invention to harvest some of this melt water 96 before it enters the sea. As in the case of water from the world's major rivers once combined with ocean water 61, melt water 96 is no longer fit for irrigation or human consumption purposes.

In one embodiment of this invention melt water 96 may be harvested before it enters the ocean causing sea level rise.

In one embodiment of this invention this melt water is then transported to a desert to be used for irrigation of said desert.

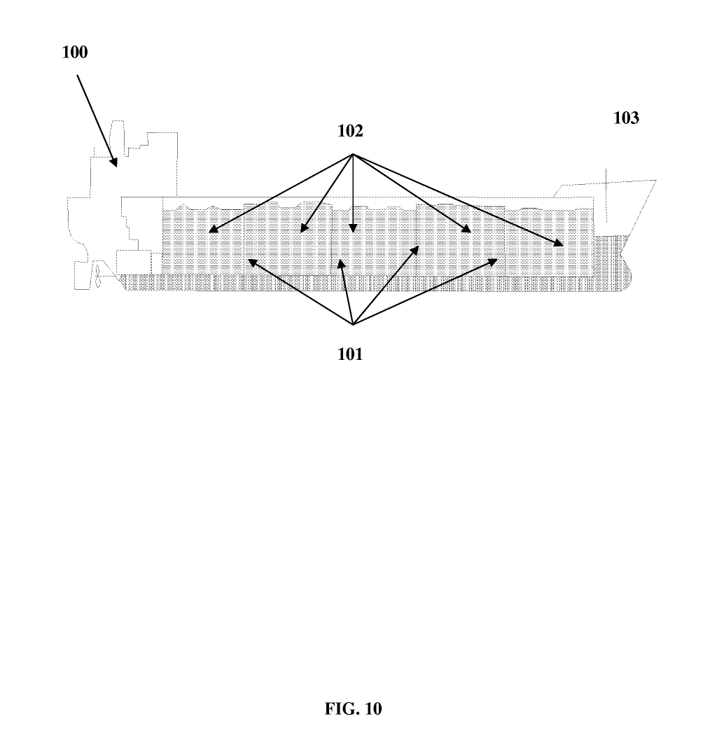

FIG. 10 is a side view of a crude oil tanker.

Crude oil tankers 100 are designed for the bulk transport of oil. Crude oil tankers 100 move large quantities of unrefined crude oil from its point of extraction to refineries.

Crude oil tankers carry oil in their cargo tanks 101 from the point of extraction to refineries on the outward leg of their journey. After offloading their crude oil 102 cargo at a refinery, empty oil tankers have to take on ballast water 103 to ensure vessel trim and stability during the deadheading portion of their voyage. Prior to loading their cargo, the tankers must discharge the ballast water 103 therefore a productive use of this deadheading portion of a tanker's round trips would be to carry desalinated water 101 from an OTEC platform, melt water 96 or outflow river water 83 to the tankers home port in the MENA, where as shown in Table 2 the world's largest hot deserts are located.

An objective of this invention is to use the deadheading portion of crude oil tankers 100 round trips to carry fresh water 80 to the desert regions of the MENA.

According to the 2006 Review of Maritime Transport by the United Nations Conference of Trade and Development, Geneva, in 2005 total world shipments of tanker cargoes reached 2.42 billion tons of which 76.7 percent was in crude oil for a total of 1.85 billion tons.

The specific gravity of Texas crude oil at 15.5° C. is 873 kg/m3 whereas pure water at 4° C.=1000 kg/m3 thus the worlds tankers transported roughly the equivalent of 1.62 billion tons of pure water which is 1.62 BCM.

Saudi Arabia is the largest producer of desalinated water in the world. In 2004 the volume of water supplied by Saudi Arabia's government-operated desalination plants reached 1.1 BCM and by 2009, new plants were expected to add an additional 0.58 BCM of water per year. Deadheading tankers could therefore match the current output of Saudi Arabia's desalination plants and could presumably double the 32,000 km² the country has currently under irrigation.

As the Quebec study referred too above found, desalination is the most currently viable means of getting fresh water into a desert environment. The exception would be carrying fresh water in an oil tankers deadheading to the MENA and accordingly it is an object of one aspect of the current invention to use deadheading tankers to carry fresh water from OC OTEC plants, icecaps or river outlets to deserts adjacent their home ports in the MENA and to expand the use of tankers for transportation of other sources of fresh water to the deserts as the economic or environmental circumstances dictate.

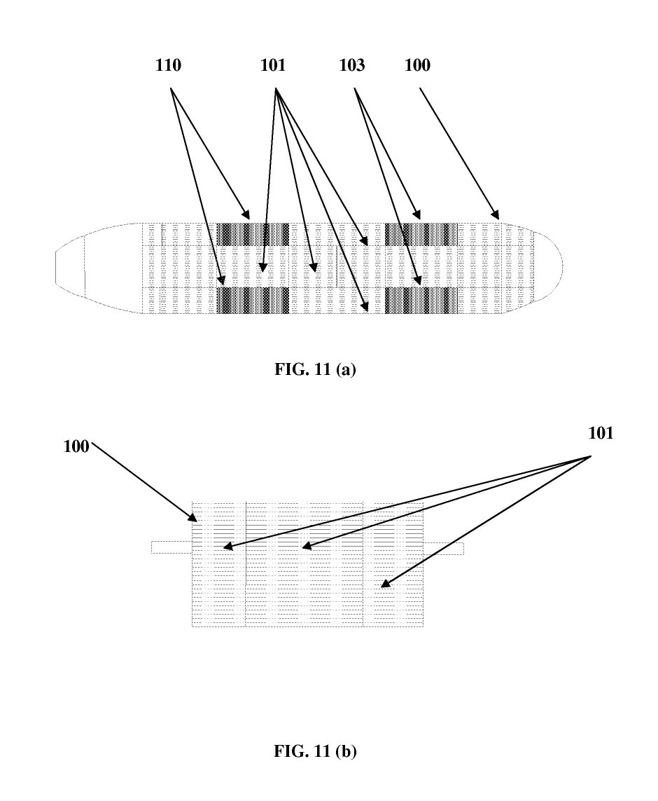

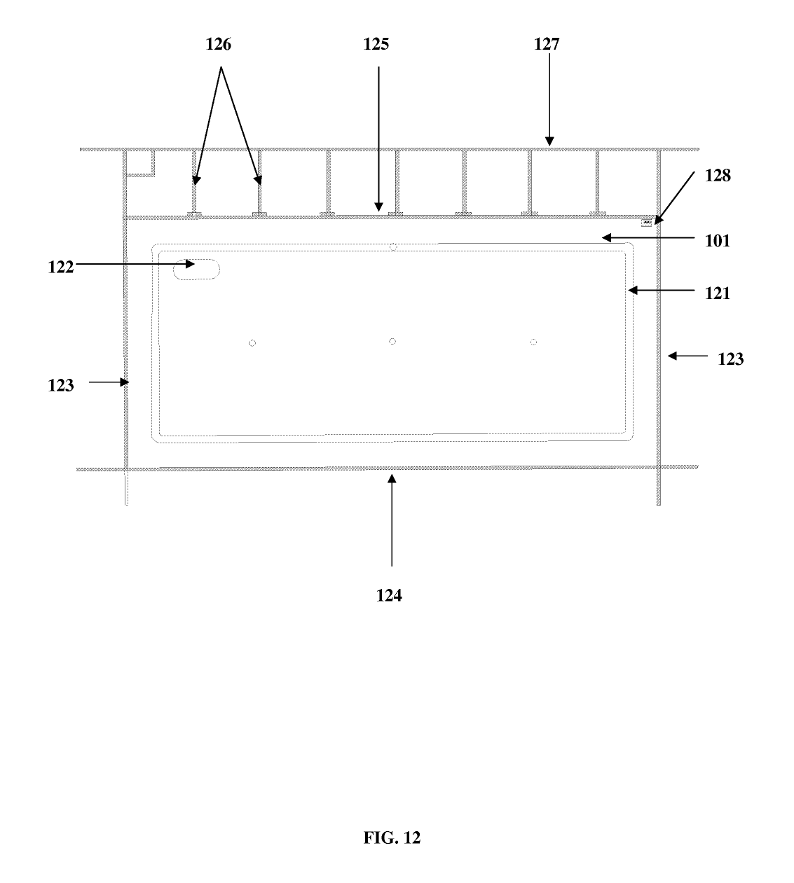

FIG. 11 (a) is plan view of a crude oil tanker.

A ballast tank 110 is a compartment within a boat, ship or other floating structure that holds water.

In 1849 Abraham Lincoln, then an Illinois attorney, patented a ballast-tank system to enable cargo vessels to pass over shoals in North American rivers.

Crude oil tankers 100 either fill “empty” cargo tanks 101 with ballast water 103 or fill dedicated ballast water tanks 110 with water for their return trips. When an empty crude oil tank 101 is filled with ballast water 103 that water is typically referred to as “unsegregated” or “dirty” ballast because the ballast 103 uses the same tanks as the crude oil 102 rather than a separate tank. Most new tankers 100 are designed with segregated ballast tanks 110, but a few older tankers are only able to carry unsegregated ballast.

Although every effort is made at the refinery to completely unload the oil 102 from the cargo tanks 101 prior to loading the tanks with ballast water 103, some residual oil 102 inevitably remains on the tank walls and floor and mixes with the ballast water 103, creating an oily water which would be unsuitable for irrigation purposes or for human consumption.

A vessel may have a single ballast tank 110 near its center or multiple ballast tanks 110 typically on either side. A large vessel typically will have several ballast tanks 110 including double bottom tanks, wing tanks as well as forepeak and aftpeak tanks. Adding ballast to a vessel lowers its center of gravity, and increases the draft of the vessel. Increased draft may be required for proper propeller immersion.

A ballast tank 110 can be filled or emptied in order to adjust the amount of ballast force. Ships designed for carrying large amounts of cargo must take on ballast water 103 for proper stability when travelling with light loads and discharge water when heavily laden with cargo.

Oil tankers 100 generally have from 8 to 12 tanks. Each tank is split into two or three independent compartments by fore-and-aft bulkheads. The tanks are numbered with tank one being the forwardmost. Individual compartments are referred to by the tank number and the athwartships position, such as “one port”, “three starboard”, or “six center.”

Normally the water used in oil tankers is ocean water 61 which like water mixed with oil is unsuitable for either human consumption or irrigation.

It is an objective of this invention to use segregated fresh water or desalinated water as ballast in oil tankers deadheading to the MENA.

FIG. 11 (b) is a mid cross section of a crude oil tanker.

In FIG. 11(b) shows a crude oil tanker 100 in cross section through its three mid cargo tanks 101.

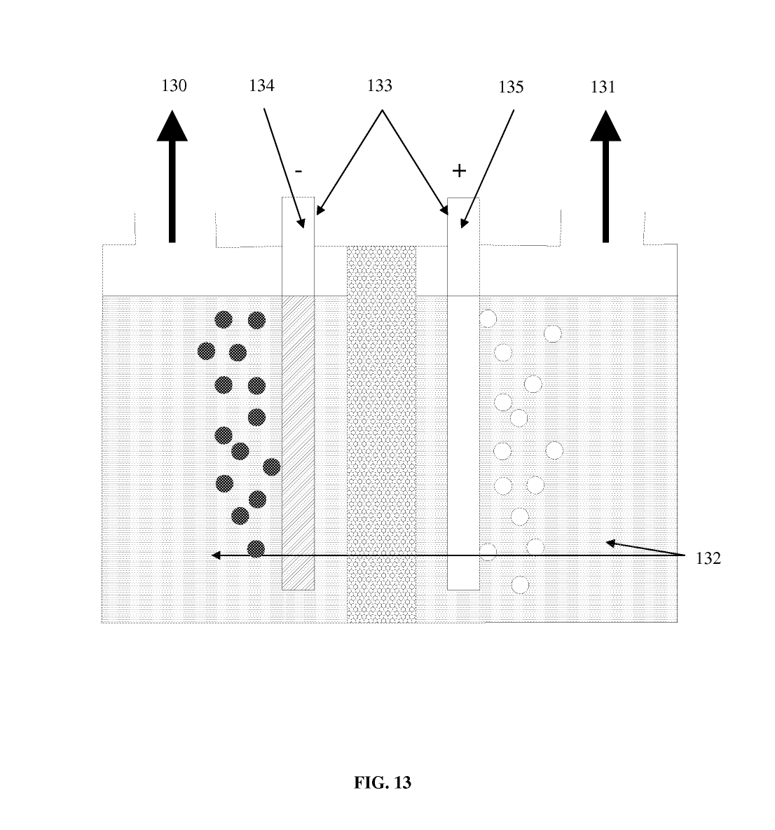

FIG. 12 is a schematic of a bladder for segregating oil and fresh water in the hold of an oil tanker for alternating trips to and from home ports.

As explained above once cargo has been discharged, tankers 100 must load ballast 103 (for weight stabilization) into their tanks. This ballast 103 is required for safety reasons when the tanker is at sea. Ballast stabilizes the ship for its return journey to the loading terminal.

The amount of ballast loaded is usually about one-third of the cargo carrying capacity of the tanker. The ballast also helps to immerse the hull, propeller, and rudder, in the sea, thereby improving the maneuvering characteristics of the ship in the light (unloaded) condition.

The International Convention for the Prevention of Marine Pollution from Ships, 1973, (the Convention) as modified by the Protocol of 1978 includes regulations aimed at preventing and minimizing pollution from ships—both accidental pollution and that from routine operations. The Convention entered into force on 2 Oct. 1983.

Previous to the Convention most oil tankers, on completion of cargo discharge, took ballast water 103 directly into the almost empty tanks from which the cargo was discharged. An unfortunate side effect of the above system was that the ballast water 103 mixed with any oil residues remaining in the tanks from the cargo. In most cases the amount of residue remaining was relatively large, and this eventually had to be pumped into the sea together with the ballast water 103 when the latter was discharged prior to loading another cargo.

The Protocol of 1978 made a number of changes to Annex I of the Convention. Segregated ballast tanks (SBT) are required on all new tankers of 20,000 dwt and above (in the parent Convention SBTs were only required on new tankers of 70,000 dwt and above). The Protocol also required SBTs to be protectively located—that is, they must be positioned in such a way that they will help protect the cargo tanks in the event of a collision or grounding.

In response to the Exxon Valdez oil spill the Protocol was amended in 1992 making it mandatory for new oil tankers to have double hulls—and it brought in a phase-in schedule for existing tankers to fit double hulls, which was subsequently revised in 2001 and 2003.

With SBTs a tanker that would historically have carried (say) 300,000 tons of cargo, is now only be able to carry approximately 200,000 tons, as approximately 100,000 tons of tank space will have to be dedicated to the carriage of ballast water 103. The SBTs is a direct and obvious loss of cargo generated revenue to the shipowner or ship charterer.

To get around this problem U.S. Pat. No. 4,409,919 describes a system whereby use is made of a double bottom tank 120, in fluid communication with a bag 121 made of reinforced elastomeric material to provide segregated ballast space in the cargo space 122 of a ship 100. The double bottom space and bag are filled with ballast water 103 when the cargo space is empty, thereby making use of the cargo space in which the bag is located to carry ballast water 103 in space previously occupied by cargo, without having any cross-contamination of the ballast water 103 by the cargo residues or gases. The outward and upward movement of the bag is restricted by a rigid guide cage. An open, or partially open, topped rigid container is placed around the guide cage to restrict the “free surface effect” of the ballast water 103 in the unlikely event of failure of the ballast bag. A header tank is provided to keep a positive pressure head on the water in the bag when in the ballast condition. A semi-flexible float assists in guiding the bag during ballasting and de-ballasting operations.

FIG. 12 is a plan view showing a ballast bag 121, which is shaped to conform with the contours of a ships ballast hold 101. A manhole 122 allows access to the interior of the hold 101 for inspection and maintenance purposes.

The transverse bulkheads 123, and port bulkhead 124. in conjunction with containment barrier 125, are used for emergency containment of the ballast water 103, in the event of a ballast bag 120 failure in the ballasted condition.

The containment barrier 125 reaches approximately the top of the cargo hold 101.

The containment barrier 125 is attached to the side frames 126, which in turn are connected to the starboard ship's side plating 127 assuming that there is not protective ballast tank on the ship's side at this position.

Remotely controlled container valve 128, is fitted as low as possible on the containment barrier 125 in order that the frame spaces may be efficiently drained of cargo oil. The container valve 128 is left open in the cargo loaded condition, and is closed in the ballasted condition.

It is an objective of the current invention to use a similar system to that described in U.S. Pat. No. 4,409,919 to carry fresh water from river runoff and/or melt water and or desalinated water from an offshore OTEC facility as ballast in deadheading tankers and to off load said fresh or desalinated water for the purpose of irrigating the deserts of the MENA.

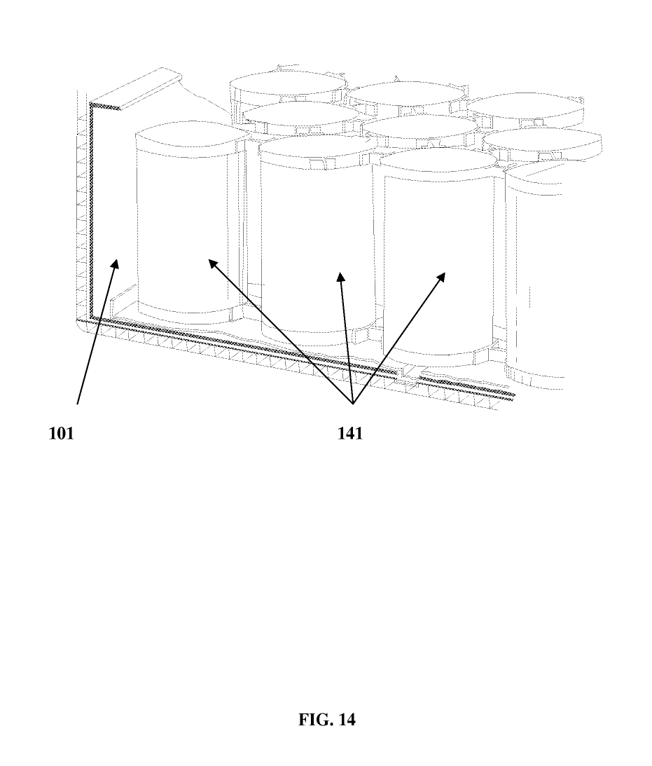

FIG. 13 is a schematic of the electrolysis process

In 1800 Alessandro Volta invented the voltaic pile, a few weeks later William Nicholson and Anthony Carlisle used it for the electrolysis of water. When Zénobe Gramme invented the Gramme machine in 1869 electrolysis of water became a cheap method for the production of H.SUB.2. A method of industrial synthesis of H.SUB.2 and O.SUB.2 through electrolysis was developed by Dmitry Lachinov in 1888.

Molecular H.SUB.2 130 is not available on Earth in convenient natural reservoirs. Most H.SUB.2 130 on Earth is bonded to O.SUB.2 131 in water 132 and it must be generated by electrolysis of water or another method.

Electrolysis is the decomposition of water ([H.SUB.2]O) 132 into O.SUB.2 131 and H.SUB.2 130 gas due to an electric current being passed through the [H.SUB.2]O 132.

An electrical power source is connected to two electrodes 133, or two plates (typically made from some inert metal such as platinum or stainless steel) which are placed in the [H.SUB.2]O 132. In a properly designed cell, H.SUB.2 130 will appear at the cathode 134 (the negatively charged electrode, where electrons enter the water 130), and O.SUB.2 131 will appear at the anode 135 (the positively charged electrode). Assuming ideal faradaic efficiency, the amount of H.SUB.2 130 generated is twice the number of moles of O.SUB.2 131, and both are proportional to the total electrical charge conducted by the solution. However, in many cells competing side reactions dominate, resulting in different products and less than ideal faradaic efficiency.

In the water at the negatively charged cathode 134, a reduction reaction takes place, with electrons (e−) from the cathode being given to hydrogen cations to form H.SUB.2 130 gas (the half reaction balanced with acid):

2H+(aq)+2e−→H.SUB.2(g) Cathode (reduction)

At the positively charged anode 135, an oxidation reaction occurs, generating O.SUB.2 131 gas and giving electrons to the anode to complete the circuit:

2[H.SUB.2]O(l)→O.SUB.2(g)+4H+(aq)+4e− Anode (oxidation)

The same half reactions can also be balanced with base as listed below. Not all half reactions must be balanced with acid or base. Many do like the oxidation or reduction of water listed here. To add half reactions they must both be balanced with either acid or base.

2[H.SUB.2]O(l)+2e−→H.SUB.2(g)+2OH−(aq) Cathode (reduction)

4OH−(aq)→O.SUB.2(g)+2[H.SUB.2]O(l)+4e− Anode (oxidation)

Combining either half reaction pair yields the same overall decomposition of water into O.SUB.2 and H.SUB.2:

2[H.SUB.2]O(l)→2H.SUB.2(g)+O.SUB.2(g) Overall reaction

The number of H.SUB.2 130 molecules produced is thus twice the number of O.SUB.2 131 molecules. Assuming equal temperature and pressure for both gases, the produced H.SUB.2 130 gas has therefore twice the volume of the produced O.SUB.2 131 gas. The number of electrons pushed through the water is twice the number of generated H.SUB.2 130 molecules and four times the number of generated O.SUB.2 131 molecules.

Pure water 132 is a fairly good insulator since it has a low autoionization, Kw=10×10−14 at room temperature and thus pure water conducts current poorly, 0.055 μS·cm−1. Unless a very large potential is applied to cause an increase in the autoionization of water the electrolysis of pure water proceeds very slowly limited by the overall conductivity.

If a water-soluble electrolyte is added, the conductivity of the water rises considerably. The electrolyte disassociates into cations and anions; the anions rush towards the anode and neutralize the buildup of positively charged Hi+ there; similarly, the cations rush towards the cathode and neutralize the buildup of negatively charged OH− there. This allows the continued flow of electricity.

Care must be taken in choosing an electrolyte, since an anion from the electrolyte is in competition with the hydroxide ions to give up an electron. An electrolyte anion with less standard electrode potential than hydroxide will be oxidized instead of the hydroxide, and no O.SUB.2 gas will be produced. A cation with a greater standard electrode potential than a H+ ion will be reduced in its stead, and no H.SUB.2 gas will be produced.

The following cations have lower electrode potential than H+ and are therefore suitable for use as electrolyte cations: Li+, Rb+, K+, Cs+, Ba2+, Sr2+, Ca2+, Na+, and Mg2+. Sodium and lithium are frequently used, as they form inexpensive, soluble salts.

Ocean water is rich in Na+cations and thus it is both conductive and suited to the production of H.SUB.2 gas by the process of electrolysis.

The hydrogen economy is a proposed system of delivering energy using H.SUB.2. The term H.SUB.2 economy was coined by John Bockris during a talk he gave in 1970 at General Motors (GM) Technical Center. A hydrogen economy is proposed to solve some of the negative effects of using hydrocarbon fuels where the carbon is released to the atmosphere.

Proponents of a world-scale hydrogen economy argue that H.SUB.2 130 can be an environmentally cleaner source of energy to end-users, particularly in transportation applications, without release of pollutants (such as particulate matter) or carbon dioxide at the point of end use. A 2004 analysis asserted that “most of the H.SUB.2 130 supply chain pathways would release significantly less carbon dioxide into the atmosphere than would gasoline used in hybrid electric vehicles” and that significant reductions in carbon dioxide emissions would be possible if carbon capture or carbon sequestration methods were utilized at the site of energy or H.SUB.2 production.

H.SUB.2 130 production is a large and growing industry. Globally, some 50 million metric tons of H.SUB.2, equal to about 170 million tons of oil equivalent, were produced in 2004. The growth rate is around 10% per year. Within the United States, 2004 production was about 11 million metric tons (MMT), an average power flow of 48 gigawatts. (For comparison, the average electric production in 2003 was some 442 gigawatts.) As of 2005, the economic value of all H.SUB.2 produced worldwide is about $135 billion per year.

H.SUB.2 130 gas must be distinguished as “technical-grade” (five nines pure), which is suitable for applications such as fuel cells, and “commercial-grade”, which has carbon- and sulphur-containing impurities, but which can be produced by the much cheaper steam-reformation process. Fuel cells require high purity H.SUB.2 because the impurities would quickly degrade the life of the fuel cell stack.

Electrolysis is a practical means of producing technical-grade H.SUB.2.

Much of the interest in the hydrogen economy concept is focused on the use of fuel cells to power electric cars. Current hydrogen fuel cells suffer from a low power-to-weight ratio, although they store more energy than other electrochemical batteries. Fuel cells are much more efficient than internal combustion engines, and produce no harmful emissions. If a practical method of H.SUB.2 storage is introduced, and fuel cells become cheaper, they can be economically viable to power hybrid fuel cell/battery vehicles, or purely fuel cell-driven ones. The economic viability of fuel cell powered vehicles will improve as the hydrocarbon fuels used in internal combustion engines become more expensive, because of the depletion of easily accessible reserves or economic accounting of environmental impact through such measures as carbon taxes.

As shown above much of the ocean area capable of producing OTEC electrical energy is far offshore. Converting this electrical energy to the energy currency H.SUB.2 is a good means of bringing this energy to where it is needed and by converting part of the ocean's liquid volume to gas by the process of electrolysis the rate of sea level rise is also reduced.

Dead zones are hypoxic (low-oxygen) areas in the world's oceans, the observed incidences of which have been increasing since oceanographers began noting them in the 1970s. These occur near inhabited coastlines, where aquatic life is most concentrated. In 2004 the UN Global Environment Outlook Year Book reported 146 dead zones in the world's oceans where marine life could not be supported due to depleted oxygen levels. Currently the most notorious dead zone is a 22,126 square kilometre region in the Gulf of Mexico, where the Mississippi River dumps high-nutrient runoff from its vast drainage basin, which includes the heart of U.S. agribusiness, the Midwest. The drainage of these nutrients are affecting important shrimp fishing grounds.

A 2008 study counted 405 dead zones worldwide.

Producing O.SUB.2 by electrolysis of ocean water in these dead zones would replenish the oxygen levels sufficiently that these zones could again support marine life.

As noted above, dissolved carbon dioxide in seawater has increased H.SUB.2 concentrations in the ocean, and thus its acidification. This acidification has negative consequences for oceanic calcifying organisms and may hamper their ability to take up carbon dioxide. O.SUB.2 produced by electrolysis of ocean water would combine with some of this increased H.SUB.2 to neutralize a portion of the ocean's acidity.

The process of electrolysis is well known does not form part of this inventive process. It is an objective of the current invention to provide a sustainable method of producing the energy currency H.SUB.2 130 in order that OTEC produced power can be transported to where it can be used and to reduce the ocean's liquid volume by converting a portion of its liquid volume to the gases H.SUB.2 and O.SUB.2. Such a liquid reduction would reduce the level of the ocean.

It is a further objective of the current invention to use the O.SUB.2 produced by the electrolysis of ocean water to revitalize some of the ocean's dead zones and to neutralize a portion of the ocean's acidity caused by increasing H.SUB.2 levels due to increased uptake of carbon dioxide by the ocean.

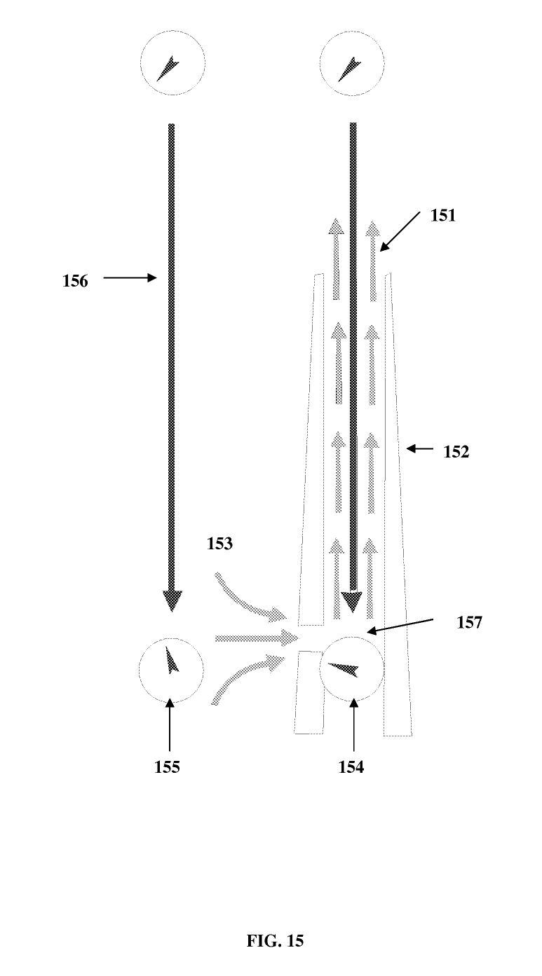

FIG. 14 is a view of a liquefied gas container

As shown in FIG. 7 the regions of the world's ocean best suited to producing OTEC energy and then to the energy currency H.SUB.2 130 are located a considerable distance from shore.

Tanker ships 100 are a viable means of conveying the H.SUB.2 from off shore to where it can be reconstituted into water and energy.

U.S. Pat. No. 4,083,318 to Ridderker, is for a Liquid Natural Gas (LNG) tanker for the storage and transport of liquefied gas at low temperatures which includes a plurality of vessels arranged in an insulated hold 101 in a vertical orientation and in an optimum space utilization pattern.

The first gas carrying ship, the Methane Princess, was taken into operation in 1964 and remained in operation until it was scrapped in 1998. Currently more than 140 vessels gas carrying ships are on order at the world's shipyards. Today the majority of the new ships under construction are in the size of 120,000 m³ to 140,000 m³. But there are orders for ships with capacity up to 260,000 m³. As of 6 Mar. 2010, there are 337 LNG ships engaged in the deep sea movement of LNG.

An LNG carrier is a tank ship designed for transporting liquefied natural gas (LNG) and can just as easily carry H.SUB.2 either in compressed or liquefied form to shore where it can be combined with resident O.SUB.2 to produce power and water.

H.SUB.2 can also power the tankers in the future thus minimizing the shipping industries climate footprint. The potential for fuel celled vessels has been demonstrated by the German navy's U32, a 212 A class hydrogen submarine which is a hydrogen hybrid vessel using fuel cells to power electric propulsion motors, which provide almost silent operation and movement. The hydrogen submarine also does not release any exhaust fumes while underwater.

In FIG. 14 tanks 141 for carrying Hydrogen either in liquid are compressed form are shown situated in the hold 101 of a ocean going tanker.

The LNG tanker is well known in the shipping industry and does not form part of this inventive process. It is an objective of one embodiment of the current invention to use LNG tankers as a means of transporting H.SUB.2 from where it is produced to where it is needed.

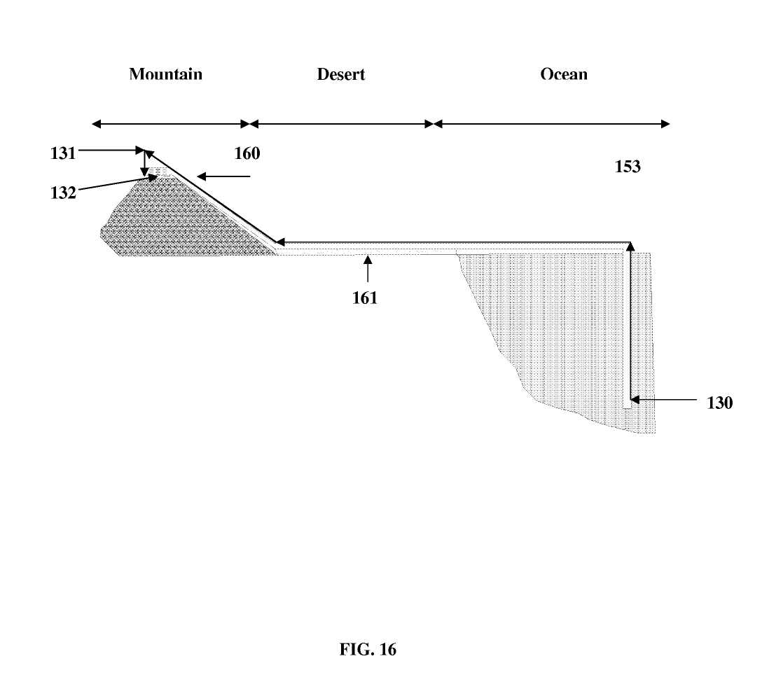

FIG. 15 is a schematic of the chimney effect The combustion flue gases 151 inside a chimney 152 are much hotter than the ambient outside air 153 and therefore less dense than the ambient air 153. The bottom of a vertical column of hot flue 151 gas have a lower pressure 154 than the pressure 155 at the bottom of a corresponding column of outside air 156 and accordingly the higher pressure 155 outside the chimney 152 is the driving force that moves the required combustion air 153 into the combustion zone 157 and also moves the flue gas 151 up and out of the chimney 152.

Hydrogen's density is much lower than that of air 153.

The density at sea-level and 0° C. for air 153 is 1.292 (g/L) and for H.SUB.2 (ρH2)=0.08988 g/L.

Buoyancy depends upon the difference of the densities (ρgas)−(pair) rather than upon their ratios.

Buoyant mass (or effective mass)=mass×(1−ρair/ρgas)

Therefore the buoyant mass for one litre of H.SUB.2 in air 153 is:

0.08988g*(1−(1.292/0.08988))=−1.202g

Where the negative signs indicates that H.SUB.2 tends to rise in air 153.

H.SUB.2 inside a chimney or pipeline would be considerably less dense than flue gases 151 and thus the column of air 156 outside the chimney 152 or pipeline would having a greater driving force to push the H.SUB.2 up the chimney 152 or a pipe line from a lower to higher elevation.

This effect would be even more dramatic if H.SUB.2 were produced by electrolysis deep below the surface of the ocean.

Atmospheric pressure at sea level is around 100 kPa but only 9.8 m below the surface of the ocean the pressure is 2 atmospheres or 200 kPa. If electrolysis took place 500 m below the surface the H.SUB.2 gas would be produced under pressure of roughly 50 atmospheres and would arrive at the surface at approximately the same pressure.

Producing pressurized H.SUB.2 would lower the effort required to compress H.SUB.2 130 for transport in a tanker 100 as described in FIG. 14 or would facilitate the transport of H.SUB.2 through a pipeline from the source of production deep in the ocean to land.

The buoyancy of H.SUB.2 affords great potential to move the gas to locations where it can be used without the need of additional mechanical or energy inputs.

It is an objective of this invention to use the natural buoyancy of H.SUB.2 as well as the pressure obtained by producing H.SUB.2 at depth in the ocean to propel the gas up a chimney or through a pipeline to where it is needed and where it can be recombined with resident O.SUB.2 to produced both water and energy.

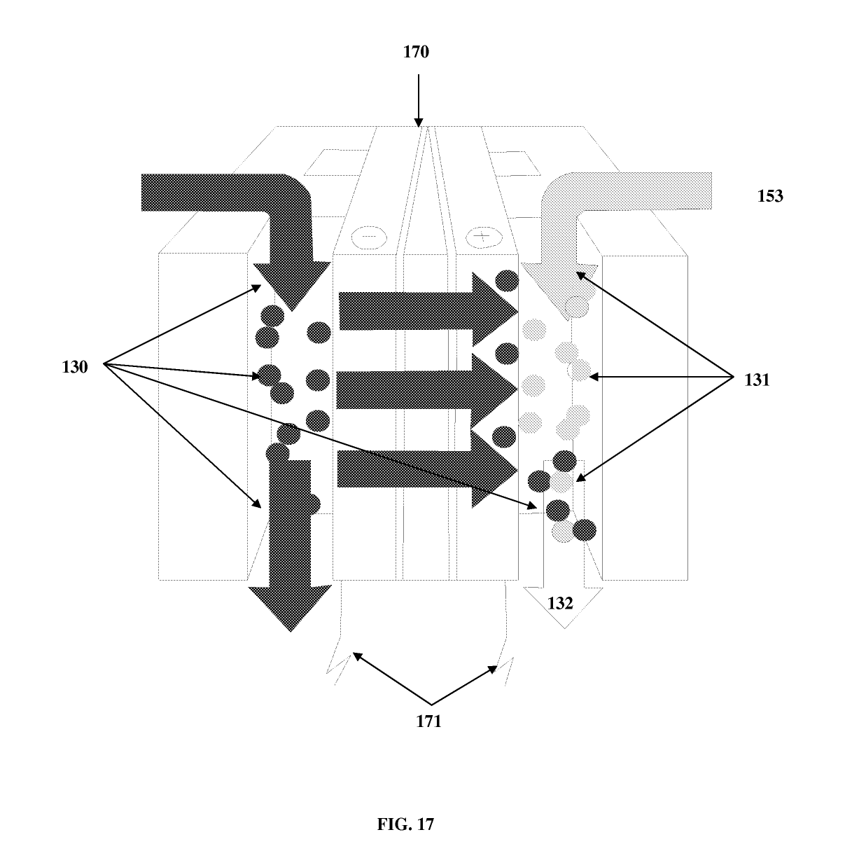

FIG. 16 is a schematic of hydrogen gas rising to an elevated point adjacent or in a desert.

As stated above H.SUB.2 130 is a water currency that can be formed from water, transported as a gas at 1/9^{th} the weight of the water from which it was formed and reconstituted as water where needed through recombination with resident atmospheric O.SUB.2 131.

The Sahara 50, with a size of 9.1 million km², is the world's largest desert, covering large parts of North Africa. Around 4 million people live here.

To the north, the Sahara 50 is bordered by the Atlas Mountains and the Mediterranean Sea; in the west by the Atlantic Ocean; in the south, the desert zone reaches 16° northern latitude; in the east it is bordered by the Nile. Still the desert continues to the east of the river until it reaches the Red Sea, but this is not considered a part of the Sahara.

The Atlas Mountains are a mountain range across a northern stretch of Africa extending about 2,500 km (1,500 miles) through Morocco, Algeria, and Tunisia. The highest peak is the Toubkal mountain, with an elevation of 4,167 metres (13,671 ft) in south western Morocco and is approximately 200 kilometres from the Atlantic Ocean 3 to the east. The Atlas ranges separate the Mediterranean 7 and Atlantic 3 coastlines from the Sahara Desert 50.

As shown in FIG. 15 H.SUB.2 130 is buoyant in air 153. It is and objective of the current invention to use this buoyancy to propel H.SUB.2 130 gas to an elevated location 160 in or near a desert 161 where combined with atmospheric O.SUB.2 131 it is converted to water 132 with gravitational potential.

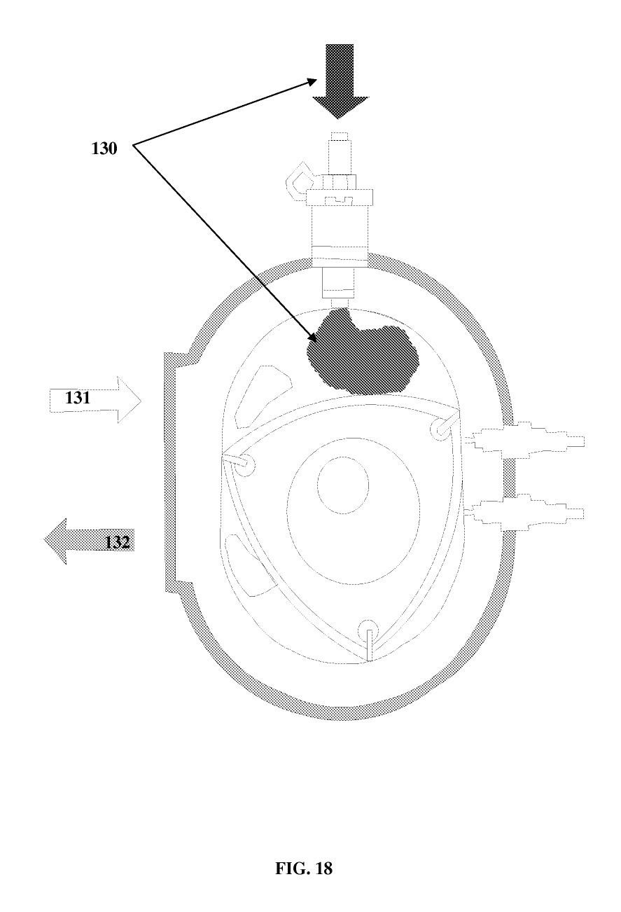

FIG. 17 is a schematic of a fuel cell

A fuel cell is an electrochemical cell that converts a source fuel into an electrical current. It generates electricity inside a cell through reactions between a fuel and an oxidant, triggered in the presence of an electrolyte. The reactants flow into the cell, and the reaction products flow out of it, while the electrolyte remains within it. Fuel cells can operate continuously as long as the necessary reactant and oxidant flows are maintained.

Fuel cells are thermodynamically open system different from conventional electrochemical cell batteries in that they consume reactant from an external source, which must be replenished. By contrast, batteries store electrical energy chemically and hence represent a thermodynamically closed system.

Many combinations of fuels and oxidants are possible. FIG. 17 is a hydrogen fuel cell 170 which uses H.SUB.2 130 as its fuel and O.SUB.2 131 (usually from air 153) as its oxidant

H.SUB.2 130 and O.SUB.2 131 combine in a hydrogen fuel cell 170 to produce electrical energy 171 in a process essentially the reverse of electrolysis.

A fuel cell uses a chemical reaction to provide an external voltage, as does a battery, but differs from a battery in that the fuel is continually supplied in the form of H.SUB.2 130 and O.SUB.2 131 gas. It can produce electrical energy 171 at a higher efficiency than just burning the H.SUB.2 to produce heat to drive a generator because it is not subject to the thermal bottleneck from the second law of thermodynamics. A hydrogen fuel cell's 170 only product is water 132, so it is pollution-free. All these features have led to periodic great excitement about the fuel cell's potential, but we are still in the process of developing that potential as a pollution-free, efficient energy source.

Fuel cells are well known and do not form part of this inventive process. It is an objective however of this invention is to use fuel cells to produce energy and water in locations where they are need from H.SUB.2 produced at sea by the process of electrolysis.

An objective of the current invention is to augment the potential of fuel cells to produce pollution-free and efficient energy by providing H.SUB.2 fuel in a manner that reduces the potential for sea level rise.

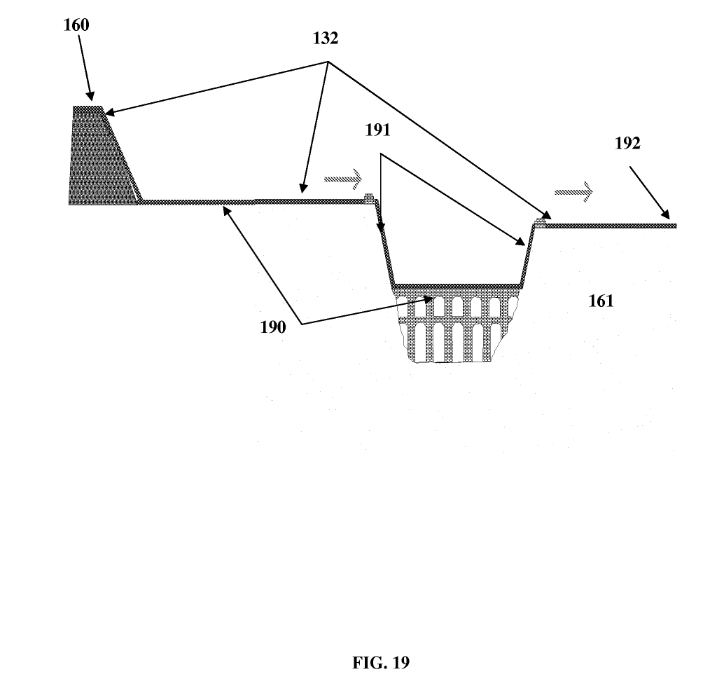

FIG. 18 is a schematic of a hydrogen powered rotary engine.

One of the main offerings of a hydrogen economy is that the fuel can replace the fossil fuel burned in internal combustion engines (ICE) and turbines as the primary way to convert chemical energy into kinetic or electrical energy; thereby eliminating greenhouse gas emissions and pollution from ICE engines.

Although H.SUB.2 can be used in a conventional ICE, fuel cells, being electrochemical, have a theoretical efficiency advantage over heat engines. Fuel cells are more expensive to produce than common ICEs, but are becoming cheaper as new technologies and production systems develop.

H.SUB.2 130 has a high energy density by weight. Its energy density is between 120 and 142 MJ/kg. It is highly flammable, needing only a small amount of energy to ignite and burn.

H.SUB.2 burns cleanly with O.SUB.2 and the only by-products are heat and water.

A four stroke ICE running on H.SUB.2 is said to have a maximum efficiency of about 38%, 8% higher than gasoline ICE.

The combination of the fuel cell and electric motor is 2-3 times more efficient than an ICE.

High capital cost of fuel cells is one of the major obstacles of their development.

Due to this high capital cost, fuel cells are technically, but not economically, more efficient than an ICE.

In 2002, typical fuel cell systems cost US$1000 per kilowatt of electric power output. In 2009, the Department of Energy reported that 80-kW automotive fuel cell system costs in volume production (projected to 500,000 units per year) are $61 per kilowatt. Their goal in order for the fuel cell to be considered competitive is $35 per kilowatt.

In view of the cost reduction between 2002 and 2009 the goal of $35 per kilowatt appears imminently attainable.

Other technical obstacles to the use of H.SUB.2 for transportation purposes are storage issues and the purity requirement of H.SUB.2 used in fuel cells—with current technology, an operating fuel cell requires the purity of H.SUB.2 to be as high as 99.999%. On the other hand, H.SUB.2 engine conversion technology is more economical than fuel cells.

In view of the perceived drawbacks to the fuel cell attempts have been made to develop internal combustion engines such as the rotary engine 180 shown in FIG. 8. to avoid the greenhouse gas and pollution problems associated with the gas powered ICE.

When evaluating costs, fossil fuels are generally used as the cheapest reference. The energy content of these fuels is not a product of human effort and so has no cost assigned to it. Only the extraction, refining, transportation and production costs are considered. On the other hand, the energy content of a unit of H.SUB.2 fuel must be manufactured, and so has a significant cost, on top of all the costs of refining, transportation, and distribution.

It is an objective of the current invention to offset the cost of production of H.SUB.2 by producing it in a manner that reduces the 28 trillion US dollars economic threat posed by sea level rise to assets in 136 global port mega-cities.

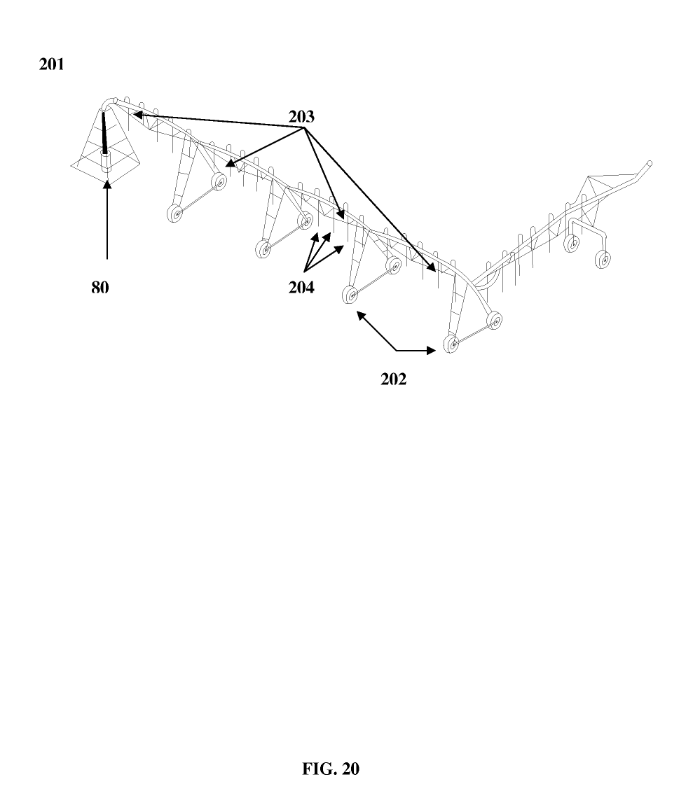

FIG. 19 is a schematic of water flowing from an elevated source to a lower desert.

An aqueduct 190 is a water supply or navigable channel (conduit) constructed to convey water. In modern engineering, the term is used for any system of pipes 191, ditches 192, canals, tunnels, and other structures used for this purpose. In a more restricted use, aqueduct (occasionally water bridge) applies to any bridge or viaduct (instead of a path, road or railway) that transports water across a gap.

Historically, agricultural societies have constructed aqueducts to irrigate crops. Archimedes invented the water screw to raise water for use in irrigation of croplands.

Another use for aqueducts 190 is to supply large cities with drinking water. Some of the Roman aqueducts still supply water to Rome today. In California, United States, three large aqueducts 190 supply water over hundreds of miles to the Los Angeles area. Two are from the Owens River area and a third is from the Colorado River.

The Central Arizona Project (CAP) is a 336 mi (541 km) diversion canal in Arizona in the United States. The aqueduct 190 diverts water from the Colorado River from Lake Havasu City near Parker into central and southern Arizona. The CAP is the largest and most expensive aqueduct system ever constructed in the United States. CAP is managed and operated by the Central Arizona Water Conservation District (CAWCD).

The CAP delivers Colorado River water, either directly or by exchange, into central and Southern Arizona. The project was envisioned by Senator Barry Goldwater, to provide water to nearly one million acres (405,000 hectares) of irrigated agricultural land areas in Maricopa, Pinal and Pima counties, as well as municipal water for several Arizona communities, including the metropolitan areas of Phoenix and Tucson. Authorization also was included for development of facilities to deliver water to Catron, Hidalgo, and Grant counties in New Mexico, but these facilities have not been constructed because of cost considerations, a lack of demand for the water, lack of repayment capability by the users, and environmental constraints. In addition to its water supply benefits, the project also provides substantial benefits from flood control, outdoor recreation, fish and wildlife conservation, and sediment control. The project was subdivided, for administration and construction purposes, into the Granite Reef, Orme, Salt-Gila, Gila River, Tucson, Indian Distribution, and Colorado River divisions. During project construction, the Orme Division was re-formulated and renamed the Regulatory Storage Division. Upon completion, the Granite Reef Division was re-named the Hayden-Rhodes Aqueduct, and the Salt-Gila Division was renamed the Fannin-McFarland Aqueduct.

In more recent times, aqueducts were used for transportation purposes to allow canal barges to cross ravines or valleys. During the Industrial Revolution of the 18th century, aqueducts were constructed as part of the boom in canal-building.

In modern civil engineering projects, detailed study and analysis of open channel flow is commonly required to support flood control, irrigation systems, and large water supply systems when an aqueduct 190 rather than a pipeline is the preferred solution.

As explained above the irrigation and planting of the world's deserts probably provides the best, near-term route to complete control of greenhouse gases. Whether or not H.SUB.2 fuel cells become practical for motive or electrical generation purposes the production of H.SUB.2 as an intermediate step in producing water that can be readily conveyed into the desert for irrigation purposes is a practical objective.

It is an objective of this invention therefore to use aqueducts 190 or like means, such as pipelines, to transport water 132 from the point of its production in an elevated region in or adjacent a desert into said desert for the purpose of irrigation of crops that will sequester greenhouse gases.

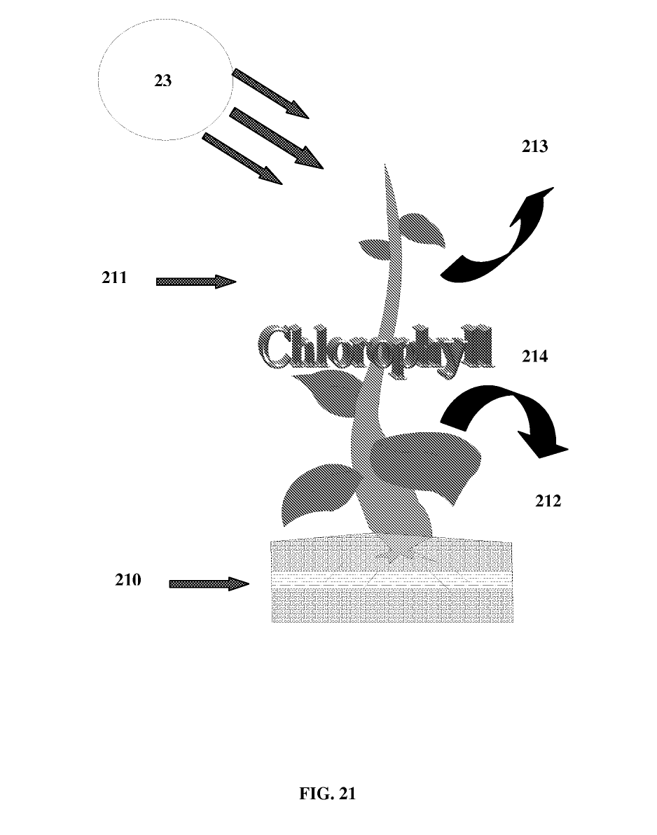

FIG. 20 depicts a typical centre-pivot irrigation system.

Centre-pivot irrigation is a method of crop irrigation in which equipment rotates around a pivot 201. A circular area centred on the pivot 201 is irrigated, often creating a circular pattern in crops when viewed from above.

Central pivot irrigation is a form of overhead (sprinkler) irrigation consisting of several segments of pipe 203 (usually galvanized steel or aluminium) joined together and supported by trusses, mounted on wheeled towers 202 with sprinklers 204 positioned along its length. The system moves in a circular pattern and is fed with water from the pivot point 201 at the centre of the circle. In the current invention the water used to irrigate deserts will be fresh runoff water 80 or desalinated water. The outside set of wheels sets the master pace for the rotation (typically once every three days). The inner sets of wheels are mounted at hubs between two segments and use angle sensors to detect when the bend at the joint exceeds a certain threshold, and thus, the wheels should be rotated to keep the segments aligned. Centre pivots are typically less than 500 m in length (circle radius) with the most common size being the standard 400 m machine. In order to achieve uniform application centre pivots require a continuously variable emitter flow rate across the radius of the machine. Nozzle sizes are smallest at in the inner spans to achieve low flow rates and increase with distance from the pivot point.

Centre Pivot Irrigation systems are used in Saudi Arabia and have demonstrated the viability of irrigating the arid and hyper-arid regions scattered about the globe.

Water is the key to viable desert agriculture. Saudi Arabia has implemented a multifaceted program to provide vast supplies of water necessary and has achieved spectacular growth of its agricultural sector. Land under cultivation has grown from under 400,000 acres (1600 km²) in 1976 to more than 8 million acres (32,000 km²) in 1993.

At the global scale 2,788,000 km² of agricultural land is equipped with irrigation infrastructure as of the year 2000. Compared to this Table 2 shows the world's hot deserts cover 15,559,000 km². The existing global scale of irrigation therefore needs to be increased by a factor of 5.59 to convert all of the world's hot deserts to agricultural use.

The process of irrigation is well known and does not form part of this inventive process. It is an objective of the current invention however to irrigate portions or all of the world's hot deserts for the purposes of growing value-added crops for food, fuel, and fibre and/or building materials. These crops would then sequester significant quantities of carbon dioxide that are causing global warming and would provide sustaining industries as well as nourishment to some the planet's poorest inhabitants.

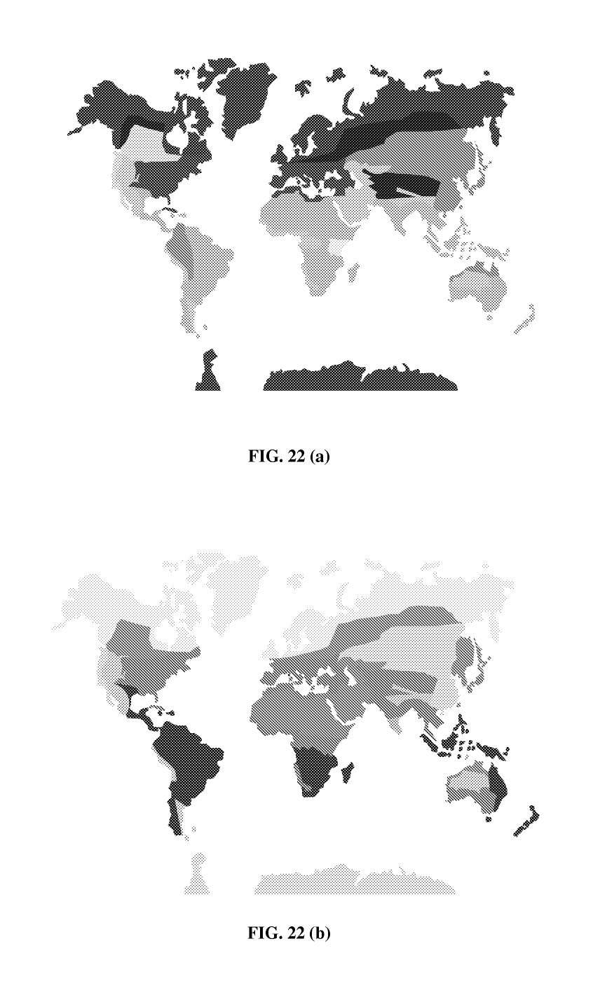

FIG. 21 depicts the process of photosynthesis.

As shown above, the world's hot deserts can grow vegetation when irrigated. As this vegetation grows it improves the sparse desert environment by increasing water and nutrient capture. These in turn increase growth in a positive feedback loop that can lead to desert recovery much more quickly than was previously expected.

The greater the rate of growth of plants the more carbon dioxide they are capable of sequestering.

Plants grow by the fundamental process of photosynthesis. The chemical formula of which is H20+CO2+Radiant Energy=C6H12O6+02.

Or as depicted in FIG. 21 water 210+carbon dioxide 211+Solar Energy 23=Sugar 212+O.SUB.2 213.

Chlorophyll 214 is vital to the photosynthesis process because it allows plants to obtain energy from light. Chlorophyll molecules 214 are specifically arranged in and around pigment protein complexes called photosystems, which are embedded in the thylakoid membranes of chloroplasts. Chlorophyll absorbs light most strongly in the blue and red but poorly in the green portions of the electromagnetic spectrum, hence the green colour of chlorophyll-containing tissues like plant leaves.

The sugar 212 produced in photosynthesis is the building block for all plant growth and therefore all higher forms of life on earth.

For every unit of carbon dioxide 211 used in photosynthesis the plant loses about 600 units of [H.SUB.2]O 210. This is known as transpiration ratio or water use efficiency and usually varies between 100 and 1000, depending on the environmental conditions.

Continued hydration is essential for plant growth therefore in present desert conditions, where hydration is sporadic at best, for the most parts plants do not grow.

Deserts are excellent sources of light energy 23 to drive the photosynthesis process but the other key ingredient, water 210, is missing. The desalination of water, by the means described above, would provide the missing ingredient for plant growth in the world's hot deserts, where the plant growth in turn can sequester large quantities of carbon dioxide 211.

Table 4 represents the atmospheric carbon balance sheet as compiled by the Soil Carbon Center of the Kansas State University.

TABLE 4

| | Carbon flux into | Movement of C out of |
|---|---|---|
| | atmosphere | atmosphere |
| Factor | (gigatons C/year) | (gigatons C/year) |
| Fossil Fuel Burning | 4-5 | |
| Soil organic matter | 61-62 | |
| oxidation/erosion | | |
| Respiration from | 50 | |
| organisms in biosphere | | |
| Deforestation | 2 | |
| Incorporation into biosphere | | (110) |
| through photosynthesis | | |
| Diffusion into oceans | | (2.5) |
| Net | 117-119 | (112.5) |
| Overall Annual Net | +4.5-6.5 | |
| Increase in Atmospheric | | |
| Carbon | | |

Table 4 demonstrates photosynthesis is far and away the best reducer of atmospheric carbon. Annually it takes up 110 billion gigatons of carbon.

The world has a landmass of 148 million km². Of this mass 27.5 million km² is Antarctica and the Artic 2 where vegetation is virtually non existent. The landmass that supports vegetation is therefore 148 million km²−27.5 million km² or 120.5 million km² upon which 110 billion gigatons of carbon are taken up annually. It is an objective of the current invention to make a portion of the world's hot deserts capable of supporting plant life, which will then sequester carbon. As shown in Table 2 these deserts cover 15.6 million km² of the Earth's surface. This area has the potential to sequester 15.6/110 or 14 percent more carbon or an additional 15.6 gigatons of carbon annually. This would over turn the atmospheric carbon balance sheet with the result as much as 11 gigatons more carbon would be taken out of the atmosphere than is input. This would not be a desirable consequence of implementing the current invention over the long-term but shows that balancing the carbon balance sheet may not be as problematical as is currently perceived. This balance may be achievable quite readily at an acceptable cost by using one or a number of aspects of the current invention in tandem.

In the short-term it might be beneficial to take up more carbon from the atmosphere than is being emitted until such time as the 280 parts per million (ppm) pre-industrial levels are restored. If climatic events dictate this lowering of carbon dioxide 211 levels in the atmosphere is necessary this aspect of the current invention would afford the means to accomplish this reduction.

Deserts can produce a variety of edible plants as well as plants that can be converted to wearing apparel or for use in construction.

For example the Sahara 50 desert is home to several species of plants that nourish its residents, and provide a lucrative business opportunity. Five plants in particular are most frequently cultivated and eaten in the Sahara 50 these are; orange trees, the herb thyme, figs, the fruit magaria and olive trees.

Bamboo is the fastest growing woody plant on the planet and thus has the potential to sequester the most carbon dioxide, the fastest.

Bamboo is the fastest growing canopy for the regreening of degraded areas and generates more O.SUB.2 than equivalent stand of trees. It lowers light intensity and protects against ultraviolet rays and is an atmospheric and soil purifier.

A viable replacement for wood, bamboo is one of the strongest building materials. Bamboo's tensile strength is 28,000 per square inch versus 23,000 for steel.

In a plot 20 m×20 m2, in the course of 5 years, two 8 m×8 m homes can be constructed from the harvest of bamboo and every year after that the yield is one additional house. It is also a source of food and provides nutrition for millions of people worldwide. Some species make fodder for animals and food for fish. Taiwan alone consumes 80,000 tons of bamboo shoots annually constituting at $50 million industry.

Bamboo's hardiness is demonstrated by the fact it was the first vegetation to grow in Hiroshima after the atomic blast of 1945 and there are a number of drought hardy bamboos, including Bambusa tuldoides, Phyllostachys mannii, Pseudosasa japonica, Bambusa multiplex, Bambusa oldhamii, Otatea acuminate aztecorum, Bambusa dissimulator, Phyllostachys rubromarginata and Sasaella masamuneana suited to growing in an irrigated desert environment.

Hemp is another potential cash crop that is both rapidly growing and can be planted in desert conditions. It is also said to both stabilize and enrich soil, as desert soils require to become more productive.

Hemp plants have deep tap root system, which enable the plant to take advantage of deep subsoil moisture, which is not as susceptible to evaporation, which is a major impediment to growth in hot deserts.

Hemp has been produced for thousands of years as a source of fibre for paper, cloth, sails/canvas and building materials. Natural fibre from the hemp stalk is extremely durable and can be used in the production of textiles, clothing, canvas, rope, cordage, archival grade paper, paper, and construction materials.

The demand for renewable raw materials is increasing. Currently many companies produce non-woven products like mats for insulation and car/vehicle composites based mainly on flax but increasingly now on hemp fibres. Hemp fibres have excellent potential—they can reinforce plastics, substitute mineral fibres, be recycled, can be grown ecologically, and have no waste disposal problems. A range of products can be derived from non-woven mats for a range of uses: insulation, filters, geotextile, growth media, reinforced plastics and composites.

Hemp is not only absorbent; it is rich in silica. When mixed with lime, hemp fibres change from a vegetable product to a mineral. In this mineral state it is often referred to as hemp stone, and it weighs between ⅕ and 1/7 that of cement based concrete. Several hundred houses have been built in Europe using this material. Research is ongoing in the UK and Germany, where hemp has been used for the construction of floors since the mid 1900s. Sometimes the hemp is mixed with lime, water and either gypsum or river sand. When poured it hardens, and becomes mould and insect resistant. It can be used in drywall construction between formwork, as an interior and exterior insulation or be poured as a floor. The formwork can be removed within a couple of hours.

The techniques for desert agriculture is well know and do not form a part of this inventive concept. It is an objective of the current invention however to facilitate sufficient growth in the world's hot deserts to overcome and/or reverse the annual build-up of atmospheric carbon.

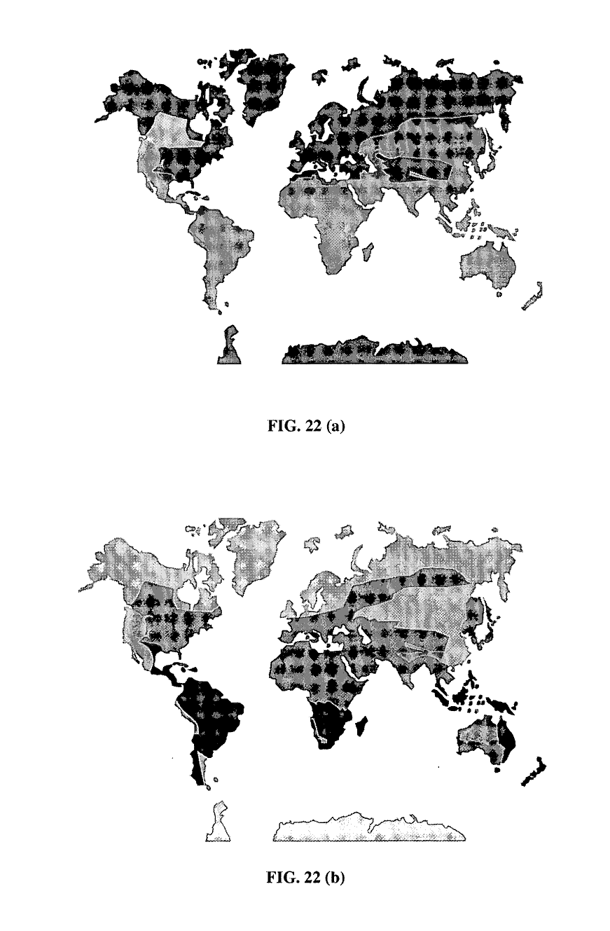

FIG. 22 (a) is a representation of the Earth's land surface temperature variations and FIG. 22 (b) is a representation of the Earth's corresponding vegetation.

Temperature is one of the three major influences on global patterns of plant growth. In FIG. 22 (a) the Earth's surface land temperatures are represented on a scale between −25° C. and 45° C. with the darkest regions the coldest and the lightest the hottest. Along with available sunlight and water, temperature determines whether the land will support dense forests, grassland, or nearly barren desert. Conversely, plants influence how hot the surface of the land can become. In areas where vegetation is dense, the land surface temperature never rises above 35 degrees Celsius. The hottest land surface temperatures on Earth are in plant-free desert landscapes as represented by FIG. 22 (b) where the dark regions are the most verdant and the light regions, corresponding to the deserts shown in FIG. 5 are the lightest.

Land surface temperature is a measurement of how hot the land is to the touch. It differs from air temperature because land heats and cools more quickly than air. Hot land does however heat the atmosphere and thus contributes to global warming.

It is an objective of the current invention to convert desert landscapes to dense vegetation and thereby moderate the heating effect of these deserts on the atmosphere, which in turn will reduce global warming.

The embodiments of the invention in which an exclusive property or privilege is claimed are defined as follows:

1. A method of reducing the rate of sea level rise, wherein heat the oceans have and are absorbing due to climate change is converted to work in an ocean thermal energy conversion system, said work produces electrical energy, said electrical energy converts a portion of the ocean's liquid volume to its gaseous components by means of electrolysis and/or fresh water is captured before it can mix with ocean water to increase the ocean's liquid volume.

2. A method as in claim 1 wherein one of the gaseous components is hydrogen.

3. A method as in claim 1 wherein one of the gaseous components is oxygen.

4. A method as in claim 1 wherein fresh water is transported to the vicinity of deserts in the Middle East and North Africa as ballast in oil tankers deadheading to their home ports.

5. A method as in claim 2 wherein hydrogen is an energy currency of light weight which is readily transported.

6. A method as in claim 2 wherein hydrogen is lighter than air.

7. A method as in claim 3 wherein oxygen replenishes the oxygen supply in an ocean dead zone.

8. A method as in claim 3 wherein oxygen combines with hydrogen to neutralize a portion of the ocean's acidity.

9. A method as in claim 3 wherein oxygen supports marine life.

10. A method as in claim 5 in which hydrogen is used as the fuel used to power tankers deadheading to their home ports.

11. A method as in claim 4 wherein fresh water is pumped into a portion of a desert.

12. A method as in claim 6 wherein hydrogen rises to an elevated region in or near a desert through a pipeline or chimney by means of the chimney effect.

13. A method as in claim 12 wherein hydrogen recombines at elevation with native oxygen to produce energy and water.

14. A method as in claim 13 wherein water at elevation posses gravitational potential.

15. A method as in claim 14 wherein water at elevation flows due to its gravitational potential to a lower desert.

16. A method as in claims 11 and 15 in which water irrigates a portion of a desert.

17. A method as in claim 16 wherein irrigation provides the hydration necessary to grow vegetation in a desert.

18. A method as in claim 17 wherein vegetation metabolizes carbon dioxide into organic compounds.

19. A method as in claim 18 wherein organic compounds metabolize carbon dioxide sufficiently to increase carbon dioxide sequestration in a desert above the current level of carbon dioxide sequestration in said desert.
